(19) United States
(12) Patent Application Publication
(10) Pub. No.: US 2026/0210864 A1
(43) Pub. Date: Jul. 23, 2026

(54) MANUFACTURING SENSORS USING CELESTIAL BODY REGOLTH

(71) Applicant: University of Central Florida Research Foundation, Inc., Orlando, FL (US)

(72) Inventors: Perla Latorre, Orlando, FL (US); Seetha Raghavan, Orlando, FL (US); Quentin Fouliard, Orlando, FL (US)

(73) Assignee: University of Central Florida Research Foundation, Inc., Orlando, FL (US)

(21) Appl. No.: 19/568,242

(22) Filed: Mar. 16, 2026

Related U.S. Application Data
(63) Continuation-in-part of application No. 18/229,572, filed on Aug. 2, 2023, now Pat. No. 12,576,583.
(60) Provisional application No. 63/394,908, filed on Aug. 3, 2022.

(51) Int. Cl. G01N 21/65; B33Y 10/00; B33Y 30/00; B33Y 80/00

(52) U.S. Cl. CPC G01N 21/65; B33Y 10/00; B33Y 30/00; B33Y 80/00

(57) ABSTRACT

In accordance with at least one aspect of this disclosure, a sensor structure, comprises a body configured to be placed on a structure or surface to monitor a load on the structure or surface to which the body is applied. The body is additively manufactured using an additive manufacturing medium comprising, at least, regolith of a celestial body. In certain embodiments, the regolith can be one or more of: a Lunar Mare regolith, a Lunar Mare regolith simulant (LMS-1), a Lunar Mare Dust regolith, a Lunar Mare Dust regolith simulant (LMS-1D), a Lunar Highlands Dust regolith, a Lunar Highlands dust regolith simulant (LHD-1D), or Martian regolith.

### CROSS-REFERENCE TO RELATED APPLICATIONS

This application is a continuation-in-part application of U.S. patent application Ser. No. 18/229,572, filed Aug. 2, 2023, which claims priority to and the benefit of U.S. Provisional Application No. 63/394,908, filed Aug. 3, 2023, the entire contents of which are herein incorporated by reference in their entirety.

### FIELD

This disclosure relates to manufacturing sensors using celestial body regolith.

### BACKGROUND

In space exploration, devices that need to be used on a celestial body (e.g., the moon) must currently be carried from earth on spacecraft to the destination. This takes up space and reduces the amount of available payload for other resources.

Such conventional methods and systems have generally been considered satisfactory for their intended purpose. However, there is still a need in the art for improved methods for having needed devices at destination celestial bodies. The present disclosure provides a solution for this need.

### SUMMARY

In accordance with at least one aspect of this disclosure, a sensor system is disclosed. The sensor system includes a sensor structure comprising a body configured to be placed on a structure or surface to monitor a load on the structure or surface to which the body is applied. Accordingly, the sensor body can be a transducer included in the sensor system. As will be described, the body is additively manufactured using an additive manufacturing medium comprising, at least, regolith of a celestial body. In certain embodiments, the regolith can be one or more of: Lunar Mare regolith or regolith simulant such as LMS-1, Lunar Mare Dust regolith or regolith simulant LMS-1D, Lunar Highlands dust regolith or regolith simulant such as LHD-1D, or Martian regolith.

In certain embodiments, the regolith includes thermoluminescent and/or photoluminescent particles, where sensor data can be collected from the sensor structure by irradiating the body while under load and observing the thermoluminescent and/or photoluminescent particles within the body for a response to the load. In certain embodiments, the sensor data is generated by utilizing Raman spectroscopy to observe load-induced variations in the body by comparing spectral peaks for the body under load to one or more known spectral peaks for a test body. The known spectral peaks for the test body represent one or more conditions such that comparison of the spectral peaks obtained from the body to the known spectral peaks for the test body provides a condition for the body which is indicative of a condition for the structure or surface to which the body is applied.

In certain embodiments, the condition includes one or more of: a stable condition, a partially stable condition, and/or a close to failure condition, or the like. In certain embodiments, the composition of the additive manufacturing medium can be selected as a function of the load to be monitored by the sensor structure and or a desired sensor sensitivity to the load to be monitored by the sensor structure. For example, in certain embodiments, the load to be monitored by the sensor structure can be one or more of a compressive load, a thermal load, and/or a chemical load.

In certain embodiments, the body can be additively manufactured using a laser-assisted sintering process. In certain such embodiments, the additive manufacturing medium can include an additive manufacturing powder formed from the regolith and in such embodiments, the additive manufacturing medium does not include a binder or matrix. In certain embodiments, the laser-assistant sintering process can operate at a temperature of about 1100° C. to about 1200° C. In certain embodiments, the particle size of the regolith can be between about 10 microns to about 30 microns.

In certain embodiments, the body can be a composite body additively manufactured using digital light processing (DLP). In certain such embodiments, the additive manufacturing medium can be a mixture of celestial body regolith (e.g., a powder) and a binder or matrix. In certain embodiments, the binder or matrix can be a resin, such as, a UV resin or an epoxy resin. In certain embodiments, the additive manufacturing medium can have a composition of about 20% regolith by volume or less, or about 10% regolith by volume or less, or from about 1% to about 5% regolith by volume, with the remainder being the resin. In certain embodiments, the particle size of the regolith can be between about 10 microns to about 30 microns.

In accordance with at least one aspect of this disclosure, a system for additively manufacturing sensors from celestial body regolith includes a spectrometer configured to receive and analyze regolith to produce regolith data and an additive manufacturing machine associated with the spectrometer to receive the regolith data and to manufacture a sensor based on the regolith data to perform a predetermined sensor function. In certain embodiments, the predetermined sensor function includes one or more of: monitoring a compressive load, monitoring a thermal load, and/or monitoring a chemical load.

In accordance with at least one aspect of this disclosure, a method includes, additively manufacturing a sensor structure body using an additive manufacturing medium comprising, at least, regolith of a celestial body.

In accordance with at least one aspect of this disclosure, a method can include additively manufacturing a sensor structure using a regolith of a celestial body. In certain embodiments, the method further includes receiving regolith spectral analysis data of the regolith, determining one or more sensor functions achievable using the regolith based on the spectral analysis data, and operating an additive manufacturing machine to construct the sensor structure using the regolith to have the one or more sensor functions. In certain embodiments, the method further includes mixing celestial body regolith with resin or matrix to create an additive manufacturing medium, and additively manufacturing the sensor structure includes additively manufacturing the sensor structure layer-by-layer using the additive manufacturing medium.

In certain embodiments, the additive manufacturing medium can have a composition of about 20% regolith by volume or less. In certain embodiments, the method can include defoaming the additive manufacturing medium after mixing and before curing. In certain embodiments, the method can include selecting the regolith to include sensor properties. In certain embodiments, additively manufacturing can include defining the sensor structure to have a sensor shape.

In certain embodiments, the resin or matrix is UV resin. In certain embodiments, the composition of the additive manufacturing medium is about 1% to about 5% regolith by volume with the remainder being the resin. In certain embodiments, a particle size of the regolith is between about 10 microns to about 30 microns. In certain embodiments, the average particle size of the regolith is about 7 microns.

In certain embodiments, additively manufacturing includes digital light processing (DLP). In certain embodiments, the regolith is Lunar Mare regolith (LMS-1), and DLP printing parameters include one or more of a layer height setting that is about 0.05, an exposure time that is about 20 seconds, a lift distance of about 5 mm, a lift speed of about 100 mm/min, a bottom exposure time of about 90 seconds, and a retract speed of about 150 mm/min. In certain embodiments, the regolith is Lunar Mare Dust (LMS-1D) regolith or Lunar Highlands dust (LHD-1D) regolith, and DLP printing parameters include one or more of a layer height setting that is about 0.05, an exposure time that is about 6 seconds, a lift distance of about 5 mm, a lift speed of about 100 mm/min, a bottom exposure time of about 45 seconds, and a retract speed of about 150 mm/min.

In certain embodiments, the regolith is lunar regolith or Martian regolith, for example.

Any other suitable celestial body regolith is contemplated herein.

In certain embodiments, the method can include using Raman spectroscopy or one or more other spectroscopy methods to compare peaks and/or other spectral properties with regolith data to design and verify sensing properties of the sensor structure.

In accordance with at least one aspect of this disclosure, a sensor can be formed of additively manufactured celestial body regolith. In certain embodiments, the celestial body regolith that forms the sensor can be lunar regolith or Martian regolith. In accordance with at least one aspect of this disclosure, a system for additively manufacturing sensors from celestial body regolith can include a spectrometer configured to receive and analyze regolith to produce regolith data, and an additive manufacturing machine associated with the spectrometer to receive the regolith data and to manufacture a sensor based on the regolith data to perform a predetermined sensor function.

These and other features of the embodiments of the subject disclosure will become more readily apparent to those skilled in the art from the following detailed description taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, embodiments thereof will be described in detail herein below with reference to certain figures, wherein:

FIG. 1 is a block flow diagram of an embodiment of a method in accordance with this disclosure.

FIG. 2 is a block flow diagram of an embodiment of a method in accordance with this disclosure.

FIG. 3 is a plan view of an embodiment of a sensor structure in accordance with this disclosure.

FIG. 4 is a schematic view of an embodiment of a system in accordance with this disclosure.

FIG. 5 is a table showing examples of materials in regolith, their associated spectral properties and a description of properties.

FIG. 6 is a table showing examples of regolith mineralogy components, a weight percent, and an associate Raman shift property.

FIG. 7 is a table showing examples of regolith compounds and an associate Raman shift property.

FIG. 8 is a table showing compositions of Martian soil, Martian simulated soil, Lunar soil, and Lunar simulated soil.

FIG. 9 is a chart of spectral properties of Mars regolith simulant, showing Raman shift.

FIG. 10 is table showing example parameters of an embodiment of a mixing method in accordance with this disclosure.

FIG. 11 is a table showing an example of printing parameters in accordance with this disclosure.

FIG. 12 is a plan view of experimental sensor structures having 1 vol % regolith (shown on left) and 5 vol % regolith (shown on right) in accordance with this disclosure.

FIG. 13 shows charts of Raman spectroscopy measurements of raw LMS-1 regolith (top) next to the Raman spectroscopy measurements of the experimental printed sensor structure (bottom).

FIG. 14 shows the graphs of results captured with lab-based diffraction of the lunar regolith simulants to determine the mineralogic composition.

FIG. 15a is a perspective view of an exemplary embodiment of a sensor structure in accordance with this disclosure, the sensor structure manufactured using DLP;

FIG. 15b is an optical micrograph of the surface of the exemplary sensor structure of FIG. 15a, showing vertical layers resulting from the DLP printing process;

FIG. 16a is a perspective view of another exemplary embodiment of a sensor structure in accordance with this disclosure, the sensor structure manufactured using a laser-assisted sintering process;

FIG. 16b is an optical micrograph of the surface of the exemplary sensor structure of FIG. 16a;

FIG. 17 shows Raman peak wave numbers and corresponding intensities for three exemplary sensor structures manufacturing using different regolith and different manufacturing processes;

FIG. 18 is a stress-strain plot observed in seven samples of exemplary sensor structures manufactured using a laser-assisted sintering process, demonstrating the variation and load drops;

FIG. 19 shows an exemplary stress-strain curve of compressive tests on an exemplary sensor structure manufactured using a laser-assisted sintering process, showing load drops due to crack formation;

FIG. 20a shows the particle size and dispersion for an exemplary sensor structure manufactured using DLP and using an LHS-1D regolith;

FIG. 20b shows the particle size and dispersion for analysis for the exemplary sensor structure of FIG. 20a;

FIG. 20c shows the particle size and dispersion for an exemplary sensor structure manufactured using DLP and using an LMS-1D regolith;

FIG. 20d shows the particle size and dispersion for analysis for the exemplary sensor structure of FIG. 20c;

FIG. 21a shows Raman spectra and peak identification of an exemplary LHS powder and an exemplary sensor structure manufactured using LHS regolith and DLP;

FIG. 21b shows Raman spectra and peak identification of an exemplary LMS powder and an exemplary sensor structure manufactured using LMS regolith and DLP;

FIG. 22a shows Pseudo-Voigt deconvolution results of an selected regolith element for a an exemplary LHS powder and an exemplary sensor structure manufactured using the LHS regolith and DLP;

FIG. 22b shows Pseudo-Voigt deconvolution results of an selected regolith element for a an exemplary LMS powder and an exemplary sensor structure manufactured using the LMS regoluth and DLP;

FIG. 23a shows the peak center positions for the deconvolution results shown in FIG. 22a;

FIG. 23b shows the Full Width Half Maximum (FWHM) for the deconvolution results shown in FIG. 22b;

FIG. 24 is a plot showing stress versus load during an experimental test of an exemplary sensor structure manufacturing using LHS regolith and DLP, the exemplary sensor structure shown on the plot before the test (left side) and after the test (right side);

FIG. 25a shows Raman spectra collected at different compression stresses highlighted in FIG. 24 for the exemplary sensor structure; FIG. 25b is an enlarged localized view of the peaks shown in FIG. 25a; and

FIG. 26 shows a graph plotting the slope between the Raman shift and the stress applied to the sensor structure under test.

### DETAILED DESCRIPTION

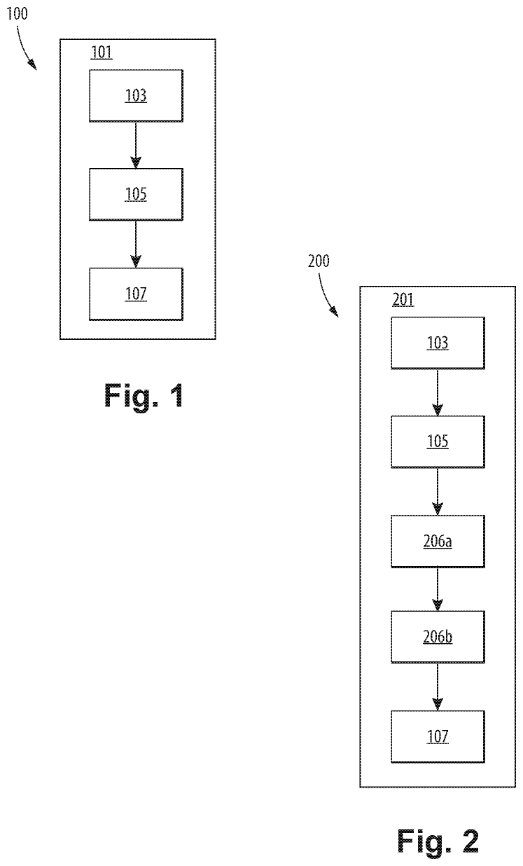

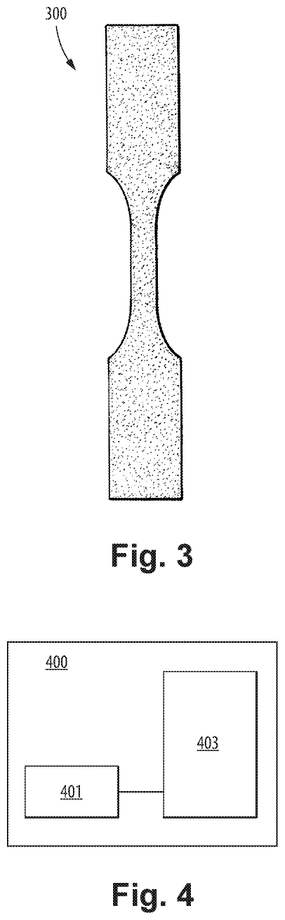

Reference will now be made to the drawings wherein like reference numerals identify similar structural features or aspects of the subject disclosure. For purposes of explanation and illustration, and not limitation, an illustrative view of an embodiment of a method in accordance with the disclosure is shown in FIG. 1 and is designated generally by reference character 100. Other embodiments and/or aspects of this disclosure are shown in FIGS. 2-26.

In accordance with at least one aspect of this disclosure, referring to FIG. 1, a method 100 can generally include additively manufacturing a sensor structure (e.g., block 101) using a regolith of a celestial body. In certain embodiments, the method further includes receiving (e.g., at block 103) regolith spectral analysis data (e.g., as described below) of the regolith, determining (e.g., at block 105) one or more sensor functions achievable using the regolith based on the spectral analysis data, and operating (e.g., at block 107) an additive manufacturing machine to construct the sensor structure using the regolith to have the one or more sensor functions.

In certain embodiments, referring to FIG. 2, the method 200 can be similar to the method 100 of FIG. 1, and can further include mixing (e.g., at block 206a) celestial body regolith with resin or matrix to create an additive manufacturing medium. Additively manufacturing the sensor structure (e.g., block 201) can include additively manufacturing the sensor structure layer-by-layer using the additive manufacturing medium.

In certain embodiments, the additive manufacturing medium can have a composition of about 20% regolith by volume or less. In certain embodiments, the method 200 can include defoaming the additive manufacturing medium (e.g., at block 206b) after mixing regolith with resin or matrix and before curing (e.g., before layerwise manufacturing/energy application).

In certain embodiments, the method 100, 200 can include selecting the regolith to include sensor properties (e.g., after block 105 and before block 107). In certain embodiments, additively manufacturing 101, 201 can include defining the sensor structure to have a sensor shape.

In certain embodiments, the resin or matrix is UV resin. In certain embodiments, the composition of the additive manufacturing medium is about 1% to about 5% regolith by volume with the remainder being the resin. In certain embodiments, a particle size of the regolith is between about 10 microns to about 30 microns. In certain embodiments, the average particle size of the regolith is about 7 microns.

In certain embodiments, additively manufacturing includes digital light processing (DLP). In certain embodiments, the regolith is Lunar Mare regolith (LMS-1), and DLP printing parameters include one or more of a layer height setting that is about 0.05, an exposure time that is about 20 seconds, a lift distance of about 5 mm, a lift speed of about 100 mm/min, a bottom exposure time of about 90 seconds, and a retract speed of about 150 mm/min. In certain embodiments, the regolith is Lunar Mare Dust (LMS-1D) regolith or Lunar Highlands dust (LHD-1D) regolith, and DLP printing parameters include one or more of a layer height setting that is about 0.05, an exposure time that is about 6 seconds, a lift distance of about 5 mm, a lift speed of about 100 mm/min, a bottom exposure time of about 45 seconds, and a retract speed of about 150 mm/min.

In certain embodiments, the regolith is lunar regolith or Martian regolith, for example. Any other suitable celestial body regolith is contemplated herein.

In certain embodiments, the method can include using Raman spectroscopy, synchrotron x-ray diffraction, or one or more other spectroscopy methods to compare peaks and/or other spectral properties with regolith data to design and verify sensing properties of the sensor structure. For example, using Raman spectroscopy peaks for determining sensor qualities is further described below.

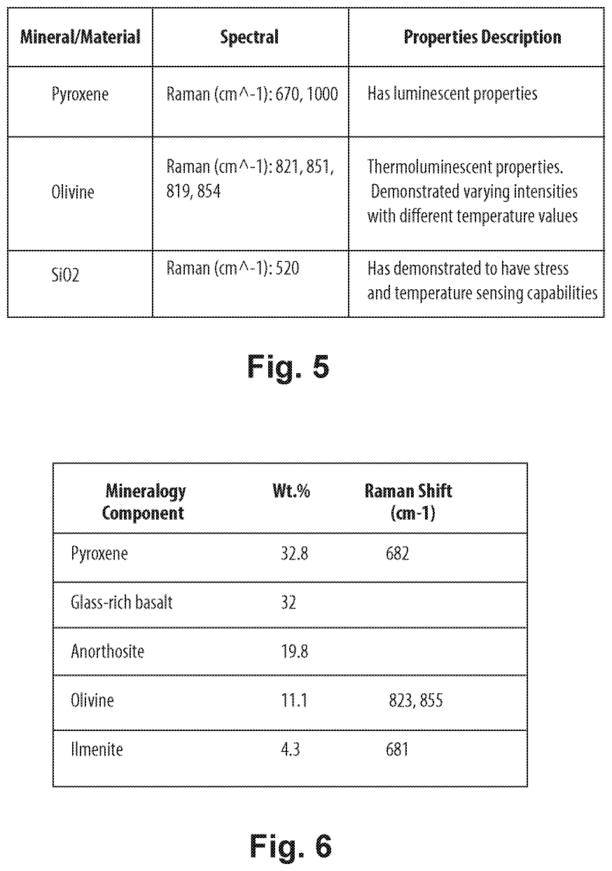

In accordance with at least one aspect of this disclosure, referring to FIG. 3, a sensor 300 can be formed of additively manufactured celestial body regolith. In certain embodiments, the celestial body regolith that forms the sensor 300 can be Lunar regolith or Martian regolith. The sensor 300 as shown can be configured to sense strain/stress, for example. However, any suitable sensor function is contemplated herein.

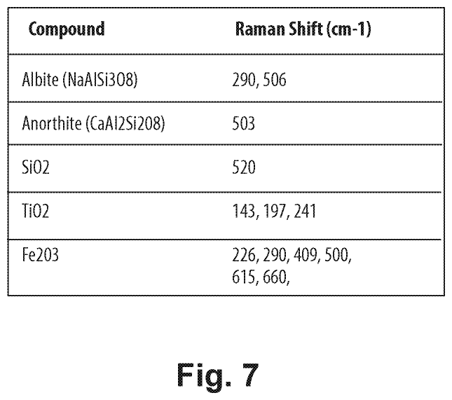

In accordance with at least one aspect of this disclosure, referring to FIG. 4, a system 400 for additively manufacturing sensors from celestial body regolith can include a spectrometer 401 configured to receive and analyze regolith to produce regolith data. The system 400 can also include an additive manufacturing machine 403 associated with the spectrometer to receive the regolith data and to manufacture a sensor based on the regolith data to perform a predetermined sensor function. The system 400 can be a rover, drone, or other suitable device configured to travel or exist on a celestial object, and/or to collect or be provided regolith for analysis and use (e.g., in accordance with one or more methods disclosed herein.

The development of the manufacturing process of the sensors using celestial body regolith is under continuous investigation. Celestial body materials and minerals can be studied with spectroscopic and high-energy x-ray diffraction techniques to determine the manufacturing parameters of the sensors. The manufacturing parameters include determining the particle size, volume fraction of the regolith or extracting the minerals from the regolith to be able to produce the technology using the sensing properties of each mineral. One having ordinary skill in the art is enabled to determine optimal volume fractions and particle size suitable to provide a desired sensing capabilities and suitable manufacturing processes for a desired sensor (e.g., having one or more applications during space exploration). One having ordinary skill in the art appreciates that experimentation to determine suitable properties of regolith and of the associated additive manufacturing process to achieve a desired result is not undue experimentation in view of this disclosure. In view of this disclosure, one having ordinary skill in the art knows how to determine sensing capabilities, for example, based on spectrometric information.

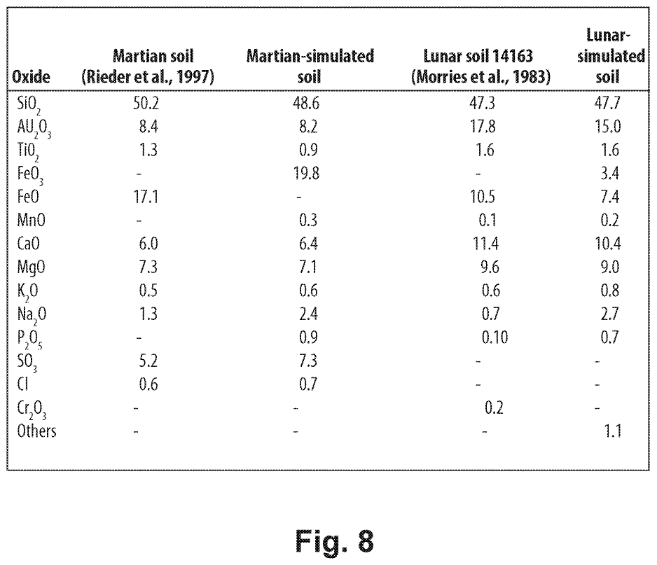

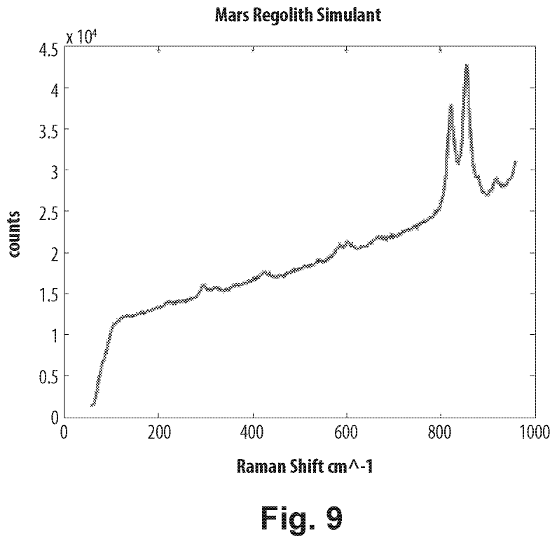

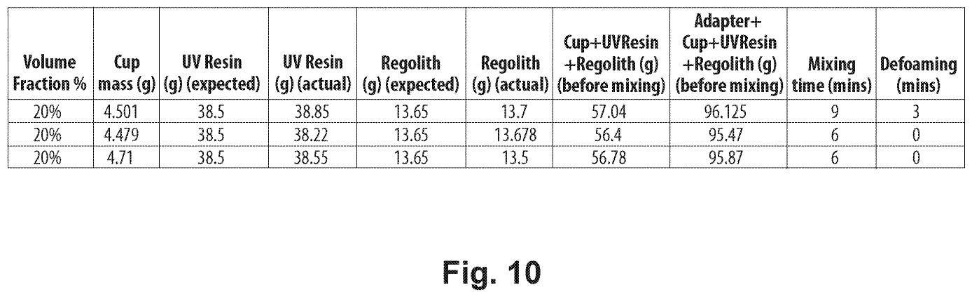

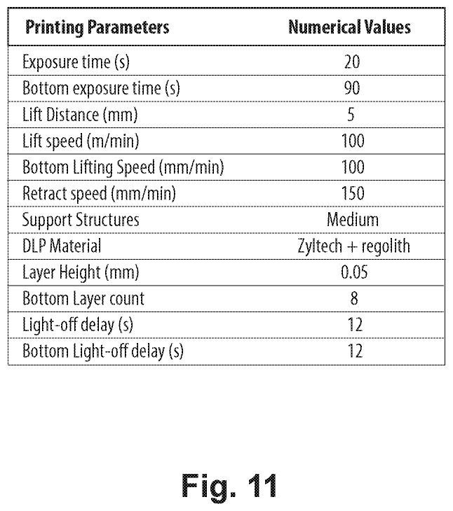

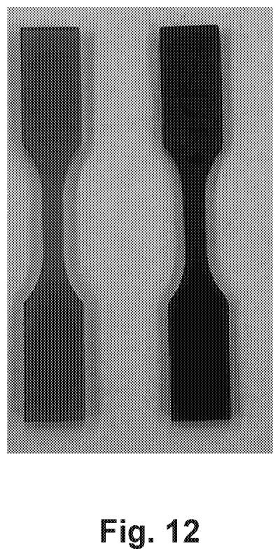

For example, referring to FIGS. 5, 6, and 7, examples of material information relating to regolith is shown. As to FIG. 5, Raman lines of silicon at 520 cm\hat{ }-1 are shifted by the application of stress. It was demonstrated that pressure in high-pressure experimental cells could be calibrated by the shift of the chromium fluorescence line from fine particles of ruby. It was also found that luminescence lines in chromium-doped sapphire were shifted by applied stress. The sharpness of fluorescence lines can depend on temperature and variations in the site position of the fluorescing atomic species. Referring to FIGS. 6 and 7, the tables show the expected peak positions for each mineral/chemical. FIG. 8 is a table showing compositions of Martian soil, Martian simulated soil, Lunar soil, and Lunar simulated soil. FIG. 9 shows a chart of spectral properties of Mars regolith simulant.

An example of a process used to make sample sensor structures is described below. The experimental mixing process used a THINKY™ mixer. The experimental process was as follows:

1. Weigh one THINKY™ cup on a mass balance and then zero out the mass.

2. Using a disposable pipette, add 38.5 g of ZYLtech™ UV resin into the THINK Y™ cup. Record the actual mass of ZYLtech™ resin. Then, zero out the mass.

3. Using a lab spatula, add regolith (mass indicated in table from previous slide) into the THINK Y™ cup. Record the actual mass of alumina. Then, zero out the mass.

4. Remove the THINKY™ cup from the mass balance, place it in the THINKY™ adapter, and then measure the total mass. Record the mass.

5. Place the THINKY™ adapter into the THINKY™ mixer. Adjust the dial to the mass recorded in STEP 4.

6. Close the lid of the THINKY™ mixer. Set the function to “MIXING”. Then set the time to 3 minutes. Press “START” to mix.

7. Set the function to “DEFOAM”. Then set the time to 3 minutes.

8. Once the THINKY™ is finished mixing and defoaming, open the THINKY™ and remove the adapter with the cup and mixture. Check the mixture. If contents of the mixture still appear separated, place the adapter with the cup and mixture and repeat Step 7 as many times as needed before proceeding to the next step.

9. Remove the adapter with the cup and mixture from the THINKY. Then, remove the cup from the adapter.

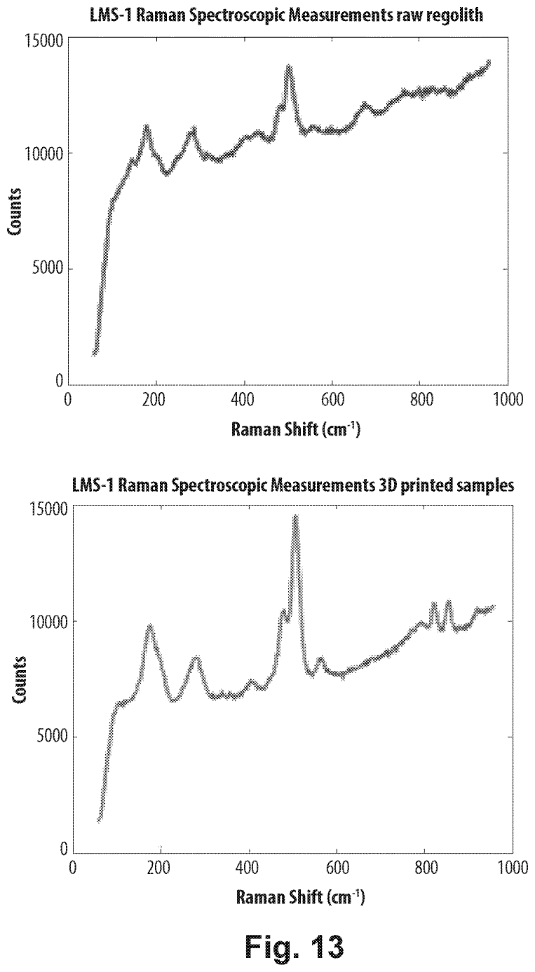

In this experiment, the THINKY™ MIXER maximum volume capacity was 50 cm³ and the minimum volume capacity was 10 cm³. The amount of mixture (e.g., liquid additive manufacturing medium) was enough to at least meet the printer's tank minimum volume. FIG. 10 shows examiner parameters for the above mixing method of a 20% regolith volume fraction mixture.

Example sensor structures were then manufactured from mixtures produced above. Mixtures were made for 1 vol %, 5 vol %, and 20 vol % to test sensing properties and additive manufacturing parameters. 20 vol % of LMS-1 regolith mixed with the UV-resin was attempted first. The mean particle size was 50 μm and the particle size range was 0.04 μm-300 μm. The particles sedimented at the bottom of the mixture.

For 1 vol % and 5 vol % mixtures, the particle size was decreased, and this improved the matrix mixture. Less particle sedimentation was observed. The mean particle size was 7 μm for these mixtures and the particle size range was about <0.04-30 μm.

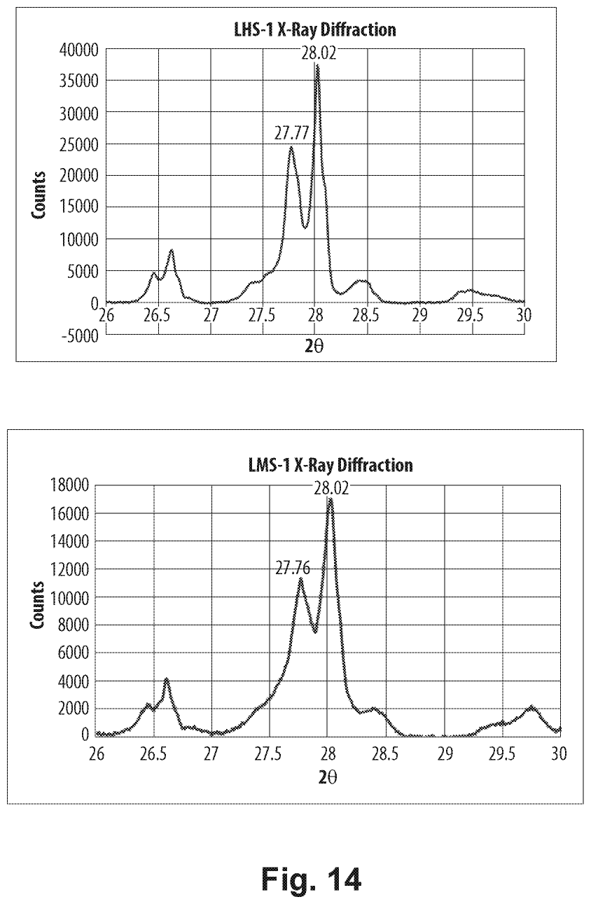

A DLP printing process was used. DLP process parameters for the experiment are shown in FIG. 11. Layer height was set at 0.05 mm and kept constant throughout the entire experiment. The samples were printed with an exposure time of 55 seconds. The bottom exposure time was 65 seconds to allow the first layer of the printed part to adhere to the build plate. The printer's resin tank volume range was 120 mL-260 mL. The ASTM D638-14 Standard Test Method for Tensile Properties of Plastics was used to manufacture the testing specimens.

After printing, the post printing process of the experimental sensor structures includes submersion in 70% isopropyl alcohol for 5 minutes and the resin residuals were removed. The samples were also exposed to a UV light source for 3 minutes on each side. This process was performed twice, with a total of 12 minutes.

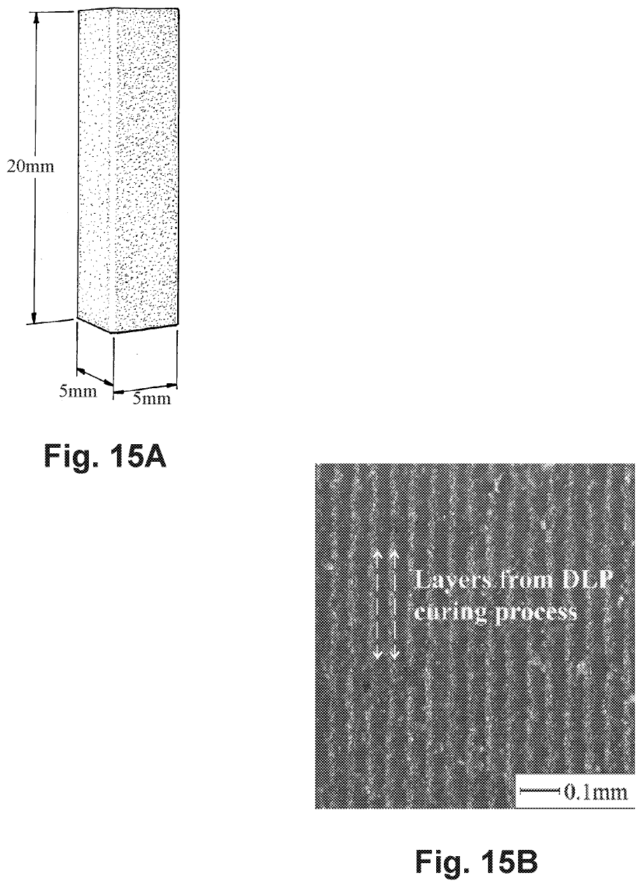

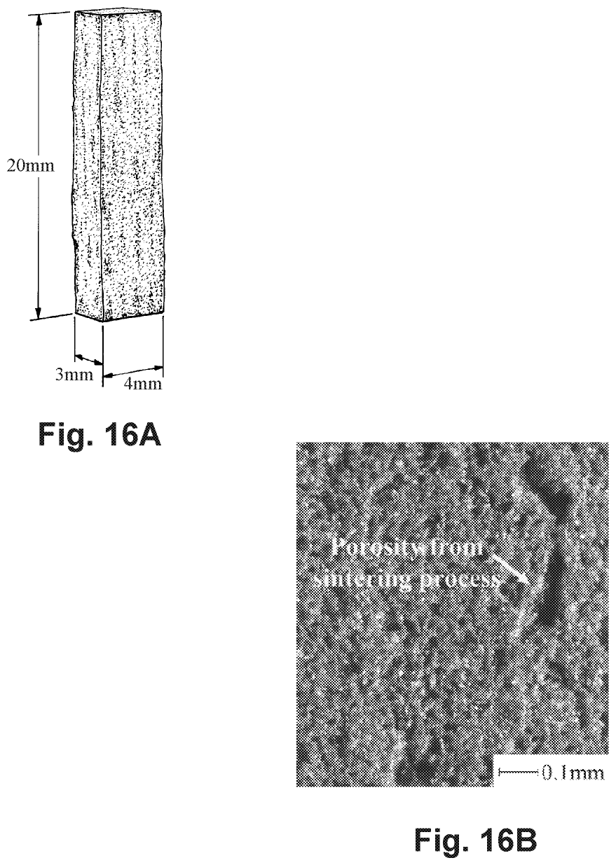

FIG. 12 shows the printed 1 vol % sensor structure (left) and 5 vol % sensor structure (right). Raman data was collected on the printed samples to compare the peaks with previous experiments. FIG. 13 shows Raman spectroscopy measurements of the raw LMS-1 regolith (left) next to the Raman spectroscopy measurements of the experimental printed sensor structure. The Raman parameters for the experiment include 20× lenses, a map size of 3.69*2 points=7.39 points each axis, exposure time of 20s, 22 minutes per map, and the scan was conducted on the rough side of the sample.

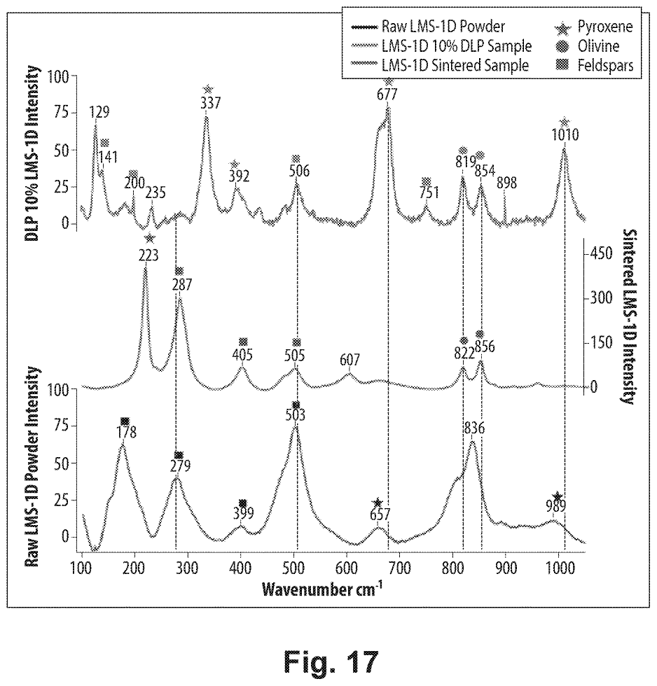

Experiments were conducted at the Argonne National Laboratory utilizing synchrotron x-ray diffraction to determine whether the minerals present in the regolith composition have sensing capabilities. FIG. 14 shows the graphs of results captured with lab-based diffraction of the lunar regolith simulants to determine the mineralogic composition. The synchrotron x-ray diffraction was performed with an energy of 59.38 kVe. Specimens with a cross-sectional area of 4×4 mm and a length of 12 mm were additively manufactured and compressively loading to a maximum load of 400 N while collection in-situ high energy x-ray diffraction data to measure the stress and any other effect on the regolith particles present in the specimen. The data collected with the synchrotron x-ray diffraction can be correlated with spectroscopic techniques such as piezospectroscopy and Raman spectroscopy to tailor its sensing capabilities. Such data allows one to determine the desired volume fraction of the regolith that should be added to collect strong signals to study the sensing properties of the material. Other parameters, such as particle size, may affect the sensing behavior of the regolith particles and may be studied with synchrotron x-ray diffraction data. One having ordinary skill in the art is enabled to collect such data without undue experimentation.

One having ordinary skill in the art can determine the desired composition and manufacturing process of the regolith sensors without undue experimentation. Other factors, such as the addition of other chemicals, compounds, or minerals, can be accounted for by one having ordinary skill in the art. Considering the possible multiple manufacturing processes of the regolith sensors, parameters such as resin compatibility, UV exposure, temperature, and particle size can be considered by one having ordinary skill in the art.

Due to the extensive mineralogic composition of the celestial regolith, minerals with sensing properties may be extracted to develop the sensors. Embodiments include technology used to manufacture the sensors in space conditions. The in-situ utilization of the lunar or celestial bodies' regolith allows for a decrease in the cargo needed during space missions. The development of the sensors using celestial body regolith allows the development of the sensors in space and provides specific information about the integrity of the components used during each mission as well as for the environment, such as gases, temperature, and pressure, surrounding the components.

Progress in space exploration activities has catalyzed a rapidly growing need to leverage in-situ resources during lunar and planetary missions. Regolith optical and sensing properties can be engineered and implemented as sensors to detect various properties including but not limited to temperature, pressure, stress, elemental quantity and dispersion. The various chemical compositions that make up lunar and planetary regolith contain elements that emit optical signals. When ingeniously engineered in specific forms and quantities, the optical signals can be harnessed to create functional sensors that monitor variables such as stress, temperature, and dispersion on the surfaces they are applied to. The configuration for creating such a sensor is non-trivial and correlates with multiple variables including composition of the primary sensing material, regolith-matrix quantities, particle size, bonding etc. that need to meet required conditions in order to produce a working sensor. As an example, lunar regolith contains silicon dioxide, the Raman signals of which can be effectively devised to capture stress and temperature by designing it with specific, defined parameters within a matrix material. Embodiments of design parameters and implementation approach disclosed herein, for example, enable creation of sensors. It has been demonstrated herein that the emission of Raman signals from Lunar simulants including the observation of a peak of silicon dioxide (520 cm\hat{ }-1). Lunar and planetary regolith may also contain aluminum oxide, which have anticipated photoluminescent properties. Luminescence as well other optical and vibrational properties of regolith can be exploited to enable the creation of stress and temperature sensors. Due to its chemical composition, lunar and planetary regolith has the potential to be engineered to create sensors and certain embodiments entail the means for doing so.

The evolution of space exploration requires the development of materials using in-situ resources found on the surface of the Moon or other planets. It is planned to use in-situ resources for in-space manufacturing, construction, energy and oxygen production. In-space manufacturing of these resources can contribute to the reduction of payloads, fuel consumption, gas emission, as well as production costs on Earth. The elements and minerals found in the lunar regolith have optical and vibrational properties that can, in theory, be engineered as sensors to monitor stress, temperature, damage, and pressure. The development of sensors using lunar and planetary regolith can provide enabling technology for exploration efforts. Lunar regolith contains significant quantities of silicon dioxide that can be utilized for stress sensitivity. Lunar regolith also contains minerals such as olivine and albite that have thermoluminescence and photoluminescence properties which can be leveraged through innovative design for temperature and pressure measurements. Raman and luminescence measurements have been used to demonstrate the proof-of-concept certain embodiments for lunar regolith simulants. Relevant lunar regolith simulant has been designed and manufactured as a sensor for characterization in our laboratory to quantify and correlate Raman and luminescence response to stress, pressure, density, and temperature data. The sensors can be monitored by exciting the sensitive particles found in the regolith with a focused laser source, scanning the surface of the material to be probed for response to external stimuli such as load, pressure or temperature. The sensitivity measured from the elements can provide real-time and adaptive data. Embodiments allow for the design and integration of sensors and can control sensitivity and performance for effective sensing. The successful implementation of this technology can significantly increase system capabilities, safety operation and life cycle. This innovative solution can address the need for space processing and autonomy, as well as the need for real-time operations, cost, and complexity using in-situ resources from the lunar and planetary surfaces.

Embodiments can provide autonomous and integrated technology that allows for in-space material characterization to allow for critical measurements such as structural health monitoring, porosity, strength, or temperature is highly needed to ensure success and safety of space exploration missions. Regolith can be found in large amounts and various forms on the surface the Moon and is expected to be the main resource to produce oxygen and to build structures at the surface of our satellite. Using regolith that is readily available on-site is expected to reduce payload, and supply the medium to establish lunar bases, protect equipment and crews from radiation and temperature fluctuations, refuel spacecrafts and prepare for deep space exploration. Lunar and Planetary regolith possess well-known compositions that can potentially be designed, engineered and calibrated to act as a sensor. Measurements provided by this technology have tremendous potential to facilitate human exploration through in-situ characterization of structures covered (structural integrity) by regolith, temperatures, density (radiation protection, quality of regolith). Embodiments can use the transformation of the most abundant resource found on planetary and lunar surfaces to manufacture sensors that can support safe and efficient human exploration missions.

Embodiments can allow creation of sensors to be used for monitoring stress and temperature in outer planetary environments and extreme conditions. Sensors can be used to assess and measure characteristics of planetary/lunar vehicles, spacecrafts, landers, habitats, and exploration instruments.

Current measurement sensors for environmental/structural health monitoring technologies used on earth components requires a complex method of evaluation. The proposed environmental/structural health monitoring method can make use of in-situ resources in the lunar and planetary surfaces while ensuring safety. This method can reduce the developmental and operational costs for the sensors and the environmental/structural health monitoring. The method of manufacture can be simple enough to autonomously develop yet customizable for the materials obtained. The sensing approach is non-contact for minimal human intervention to achieve data collection.

Regolith is not strictly identical in composition across the surface of the Moon or other planetary surfaces. Regolith properties such as density, particle size distribution, thickness of the regolith change with extraction depth and location. The devising of a sensor configuration that optimally delivers a sensing mechanism is non-trivial. Certain embodiments utilize a multi-disciplinary knowledge in mechanics, optics and materials to achieve new and significant measurement capabilities. Embodiments can help to ensure safety and efficiency while monitoring the environmental exposure and structural cycle life of the components and vehicles used in lunar and planetary surfaces. Embodiments can include a space exploration device that includes integration of a manufacturing device or 3D printer that can operate in space environments.

The term “celestial body” as used herein means any suitable extraterrestrial body (extraterrestrial meaning not including Earth). For example, the term celestial body includes, but is not limited to, planets (e.g., Mars), moons (e.g., the moon), asteroids, comets, or any other natural space object having regolith.

Embodiments can include any suitable computer hardware and/or software module(s) to perform any suitable function (e.g., as disclosed herein). For example, a system can include an additive manufacturing system configured to perform a method as disclosed herein (e.g., selecting regolith based on composition, mixing regolith with a resin or matrix, and additively manufacturing a sensor component) autonomously and/or with manual control.

Embodiments can include methods and systems configured to manufacture sensors using the properties from the lunar and other planetary regolith. The sensors can have the ability to sense and monitor effects from the components that will be used for lunar exploration.

Embodiments include a manufacturing process for sensors to develop the sensors to monitor the devices and structures that will be used in space. Space exploration has been evolving, where structures and stations will be built at the lunar surface, for example. The regolith can be used at a lunar base, for example, for sensor components due to the properties that it possesses. The method can include determining optical properties of regolith for a particular sensor, and additively manufacturing a functional sensor from the regolith based on the optical properties of the regolith.

In certain additive manufacturing methods, the maximum volume percentages for regolith vs resin or matrix or other binder medium can change as a function of several variables (e.g., composition, particle size, sensor type/function, etc.). Certain embodiments can have a 20% maximum volume fraction, however, any other suitable fraction to result in a desired sensor function and/or form factor is contemplated herein. In certain embodiments, particle size for such a volume fraction can have a range of 0 to 1000 microns and a median particle size of 88 microns. Any other suitable particle size and volume fraction for a desired sensor function is contemplated herein.

Embodiments can include methods and systems for characterizing regolith as a sensor using optical analysis. For example, embodiments can include collecting regolith and determining one or more material properties for use as a sensor, e.g., using spectral analysis. Embodiments can include determining what type of sensor the regolith can be used to make based on the one or more material properties. Embodiments can include making a sensor with the regolith based on the one or more material properties such that the sensor has a predetermined sensing function.

Embodiments can be made with any suitable additive manufacturing method with any suitable other medium/resin or matrix. For example, embodiments can use a UV resin, for example. Other mixing agents such as epoxy can be used, for example.

Goals for sustained extra-terrestrial human presence have greatly accelerated research and development, including in the technologies related to the use of in-situ resources, such as lunar and planetary regolith, to develop structural materials for habitats, landing pads, and other infrastructure in low gravity environments. Materials for construction have been developed by converting regolith into geopolymers with alkaline solutions like sodium silicate. See, for example, Peter J. Collins, Jennifer Edmunson, Michael Fiske, Aleksandra Radlińska, “Materials characterization of various lunar regolith simulants for use in geopolymer lunar concrete,” Advances in Space Research, Volume 69, Issue 11, 2022, Pages 3941-3951, ISSN 0273-1177, which is incorporated herein by reference in its entirety. Collins et al. have found that the compressive strength of lunar regolith geopolymers can reach 18-30 MPa, making them suitable for in-situ construction on the Moon. Additionally, recent work explored the effect of sintering temperature in the manufacturing of lunar and Martian regolith demonstrating the optimal sintering temperature is somewhere between 1100° C. and 1200° C. See, for example, Warren et al. “Effect of Sintering Temperature on Microstructure and Mechanical Properties of Molded Martian and Lunar Regolith” Ceramics International, 2022, which is incorporated herein by reference in its entirety.

Significant focus has, therefore, been on designing structural materials with lunar and planetary regolith. However, safe long-duration exploration will require the creation of functional materials from in-situ resources. It is important to investigate the properties of these extraterrestrial materials that can be leveraged in support of the various systems needed to maintain a human presence on the Moon. Of key interest, and the area studied by the inventors of this application is the design of sensors, tailored to identify damage in supporting structures or monitor significant temperature or pressure changes, where in-situ resources to create such sensors in space.

When considering the lunar environment, the approach of using Raman and Luminescence spectroscopy as measurement methods is robust and well tested. Therefore, the operation of functional sensors in space that depend on spectral response of lunar regolith to external stimuli, such as stress and temperature, are not anticipated to be affected by the lunar environment. However, in-space manufacturing of these functional sensors is of interest in order to avoid cost, volume, and up-mass constraints. When manufactured in low-gravity environments, for purposes of in-situ resource utilization, there will be differences in material and potentially sensor properties, when compared to manufacturing on Earth. These differences are likely to be dependent on the manufacturing process.

Two manufacturing approaches are described herein, including 3D printing of regolith-loaded resin (cured using Digital Light Processing (DLP)) and manufacturing of regolith using a binderless sintering process. In each of these processes, it is anticipated that the properties achieved in the investigations described here are likely to be affected in different ways when manufacturing in a low-gravity environment. The effect of each of these manufacturing processes influences the measured spectral emissions and mechanical properties of the sensor should be first assessed.

Building on the principles of elastic thermobarometry, the equations of state and elastic properties of regolith particles can be leveraged to convert measured strains into estimates of the pressure-temperature conditions experienced by the material. This is possible due to the contrasting compressibility and thermal expansivities resulting from thermal cycling or applied loads, for example, which induce differential strains between the matrix and its inclusions. These strains can be quantified in situ using Raman spectroscopy, effectively transforming regolith composites into functional sensors.

Thus, in accordance with at least one aspect of this disclosure, the inventors disclose one or more embodiments of functional sensors manufactured from lunar regolith. This is accomplished by exploring spectral properties of samples manufactured using two different approaches. The effect of the manufacturing processes on the spectral properties that are of significance for sensor creation is the focus of the results presented. The mechanical properties of these sensors are also of interest for their longevity under harsh lunar conditions. The ground reference study disclosed herein provides an insight into differences in manufacturing of the regolith sensors and their spectral behavior, paving the way to future systematic assessments of the impact of low-gravity environment on manufacturing and consequent sensor performance using an optimized processing approach.

In accordance with at least one aspect of this disclosure, the materials, manufacturing processes, Raman measurement parameters and mechanical testing methods are used and explained further below. In certain embodiments, LMS-1D simulant was manufactured into samples using two separate processing approaches described here and the samples for each were investigated using Raman spectroscopy. In embodiments, mechanical testing was conducted to assess sensor material strength under compressive loads.

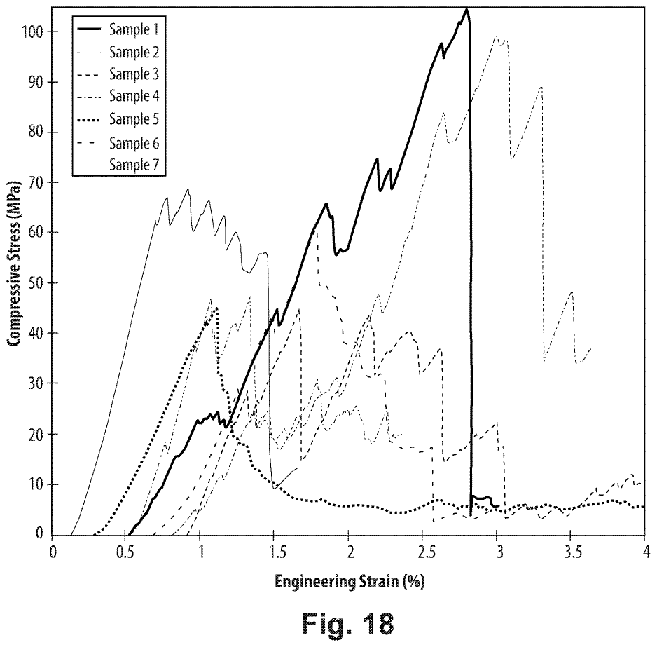

In certain embodiments, a first approach is used, wherein a resin-regolith (Zyltech-LMS-1D) composite was manufactured via Digital Light Processing (DLP) 3D printing. In this example, the desired regolith weight fraction selected was 10 wt % with the goal of enabling sufficient particle concentration for spectral data, while maintaining the structural integrity of the sample to avoid brittleness and delamination. The optical image of the resin-regolith DLP sample is shown in FIG. 15a. The vertical line patterns observed with the partial ring Epi-illuminated microscope is a characteristic feature of DLP printing, as the curing process occurs layer by layer, leading to the visible texture in the final sample. In FIG. 15a an embodiment of a DLP printed LMS-1D sample camera image is shown, and in FIG. 15b, optical micrograph of the surface is shown.

In the mixing process for this example, the desired amount of resin and regolith were added together and thoroughly mixed under a fume hood. The THINKY mixer AR-100 was used for the mixing process with three minutes of mixing, ensuring particle dispersion. Three minutes of defoaming helped to mitigate entrapped microbubbles within the matrix. After mixing, the suspensions were stored in dark containers to avoid light and airflow. Samples were then printed using a DLP printer with a 5 μm layer thickness and cured with 405 nm UV light for 6 seconds per layer. Post-processing included an isopropyl alcohol wash and additional UV curing for 3 minutes on each side of the sample. The parallelepiped samples of 10% wt fraction, with a square cross-section of 5 mm and 4:1 aspect ratio, produced by this approach are referred to in the paper as the DLP samples.

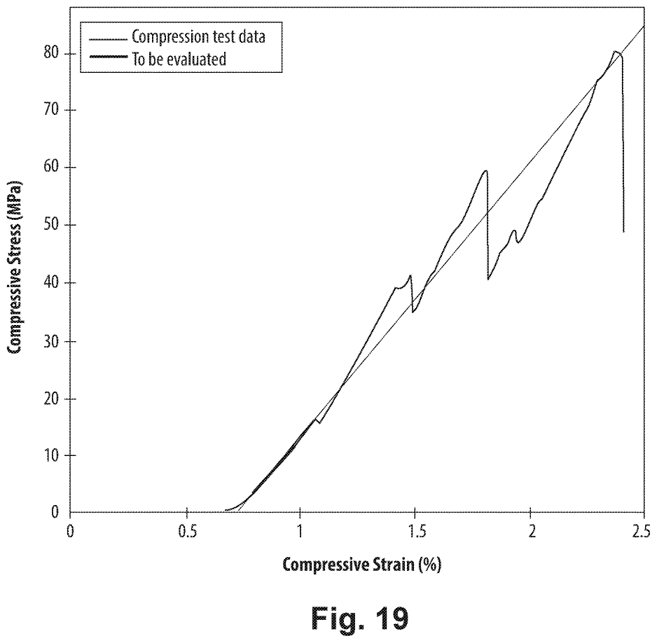

In certain embodiments, a second approach is used, wherein the LMS-1D was consolidated without a binder and sintered at 1150° C. The sintered samples were then machined using a diamond wire-cutter to produce parallelepiped parts of 3 mm width, 4 mm height, and 20 mm length. The samples were polished and then investigated using optical microscopy and a representative image is shown in FIG. 16a. It is observed that although the sample was polished, some areas remained rough due to inherent porosity in the material, for example as shown in FIG. 16b.

SEM images of the samples from the second approach show porosity more clearly on the sample's surface. The dense part between the pores indicates that general consolidation of particles has occurred during the sintering process, since no individual powder particles were discernible. The pores vary in size and shape with dimensions of about 5 to 20 μm. Some of the constituent elements segregate during the sintering process, resulting in regions with varying elemental composition, such as an iron-rich region observed using energy-dispersive X-ray spectroscopy (“EDS”) mapping.

In certain embodiments, the Raman measurements were collected using a WITec Alpha 300RA Confocal Raman microscope equipped with a He:Ne 532 nm laser excitation source. The lens used for the measurements was a Zeiss EC Epiplan-Neofluar Dic 100×. The excitation laser power of 10 mW, 1800 g/mm grating and additional collection parameters, including 20 accumulations of 2 seconds integration time, remained constant throughout the measurements.

The Raman data was then analyzed using a Python code for background subtraction and processing.

In certain embodiments, compressive tests were performed on the parallelepiped specimens cut from sintered regolith material. The specimens had a nominal cross section of 3 mm×4 mm and a length of 20 mm. An electro-mechanical universal testing machine (Instron LLC), equipped with a 10 kN load cell, was used for applying the load. The specimens were clamped between to plan parallel plates, and a compressive load was applied along the length axis of the specimens. The compressive tests were displacement controlled with a displacement rate of 5 mm/min. The displacement and the load were recorded and the stress-strain behavior was analyzed. Further, videos of the experiments were recorded. Compressive tests on the DLP samples are estimated to be about one order of magnitude lower in strength than the sintered samples due to the low volume fraction of regolith.

Using the data gathered, the inventors have found that measurements of stress, damage and temperature can be achieved on the regolith functional sensors using optical measurements from luminescence or Raman emissions of ceramic materials. For example, the Raman peak of silicon at 520 cm-1 is known for its shift with the application of stress. Similarly, the photo-luminescence lines in chromium-doped sapphire have been calibrated for their peak shift with applied stress. For the case where these ceramics are deployed as particles within a composite, the shift Dn can be measured against a strain gage measurement of the composite. The transformation between the two measurements can then be shown to be a combination of ratios in Equation (1) that can be analytically established based on the mechanical properties of the luminescent particle and the composite. This relationship is usually defined as the composite's piezospectroscopic coefficient (Π_{c}). Calibration measurements can experimentally establish the coefficient.

$$Δ v = \frac{Δ v}{{ε}_{i i}^{p}} \frac{{ε}_{i i}^{p}}{{ε}_{i i}^{c}} \frac{{ε}_{i i}^{c}}{{ε}_{1}^{c}} {ε}_{1}^{c} = {\prod }_{c} {ε}_{1}^{c} \qquad ( 1 )$$

Distribution of intensities collected from the composite can identify variation in the dispersion of particles in samples manufactured.

In phosphor thermometry, the temperature sensitivity of the luminescence of transition metals or rare-earth elements that are added as dopants in host materials is used to establish temperature. Rare earth elements have been utilized for their luminescence decay with the objective of developing temperature-sensing capabilities. The natural thermoluminescence (TL) of lunar regolith can be used in a similar way to measure temperature. The excitation of the luminescent material by a laser source of a particular wavelength is selected based on the absorption spectra of the material. The decay in intensity is represented in Equation 2.

$$I ( T ) = {n}_{o} s {e}^{( - \frac{E}{k T} )} e \{ - \int s {e}^{( - \frac{E}{k T} ) / β} \} d T \qquad ( 2 )$$

E(eV) is the activation energy for electrons to escape a trap in the crystal lattice, and s (s⁻¹) is an Arrhenius factor for the probability of an electron escaping the trap.

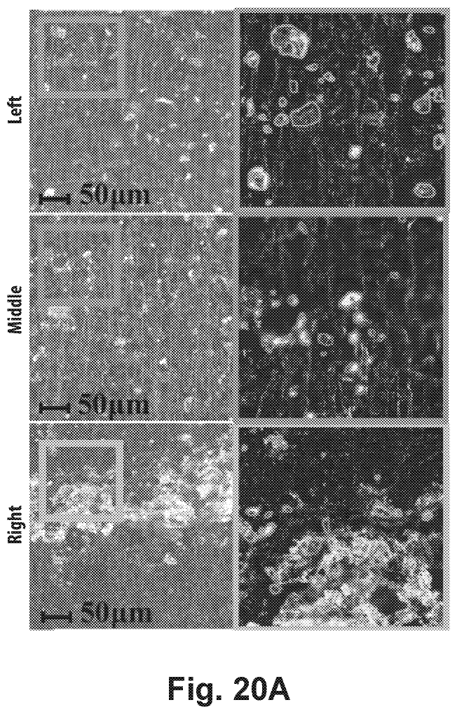

The results of the Raman measurements and the mechanical tests are presented and discussed in the context of the different manufacturing approaches. For example, FIG. 17 shows the Raman spectra of the samples from each manufacturing approach compared with raw powder along with a number of peaks marked. The minerals described in Table 1 are identified in the spectra of FIG. 17.

TABLE 1

| [symbol] | | [symbol] | |
|---|---|---|---|
| Mineral/ | | Raman | Expected |
| Compound | wt % | (cm⁻¹) | Sensitivity |
| Pyroxene | 32.8 | 228, 338, 657, | Luminescence |
| | | 679, 995, 1007 | |
| Glass-rich | 32 | 757, 970 | — |
| Basalt | | | |
| Anorthosite | 19.8 | 198, 285, 404, | — |
| | | 504 | |
| Olivine | 11.1 | 819, 848 | Thermo- |
| | | | luminescence |
| Ilmenite | 4.3 | 681 | — |
| SiO₂ | — | 520 | Stress, |
| | | | Temperature |

[symbol]

indicates data missing or illegible when filed

As a first observation, the Raman peaks from the spectral data of raw powders are generally conserved in the parts manufactured using either one of the two processes. The spectral intensities are seen to vary differently in each of the DLP and sintered samples. In the case of Anorthosite, which is primarily composed of Anorthite, a calcic plagioclase feldspar, a characteristic doublet around 504 cm⁻¹ is observed. While the intensity of this doublet decreases in both manufactured samples, it remains more distinct in the DLP-printed sample. The UV curing process in DLP printing may have induced residual stress on the particles due to the solidification of the surrounding matrix contributing to the clear differentiation of the doublet. Similarly, residual stress could be introduced in the sintering process due to high consolidation temperatures, leading to broader and shifted peaks.

FIG. 17 shows Raman peak wavenumber (cm⁻¹) and corresponding intensities (CCD counts) of LMS-1D samples, including raw powder (bottom curve), sintered samples (middle curve), and DLP-printed 10% wt composite (top curve). Known mineral peaks are indicated, with pyroxene (stars), olivine (circles), and feldspars (squares) marked for reference. The linewidth of full width half maximum (FHWM) is wider for the raw powders, and the emergence of clear peaks for the DLP sample is due to the more distinct narrow wavelengths. The linewidth is typically representative of grain sizes but is also affected by residual stress.

The emergence of some of the peaks is likely due to the changes in peak positions and linewidths making some broad peaks appear. Peak shifts are seen for a number of the minerals such as Olivine. It is contemplated herein that calibration of the intensity ratios, peak positions and linewidth with temperature and stress can be used for the development of sensing properties.

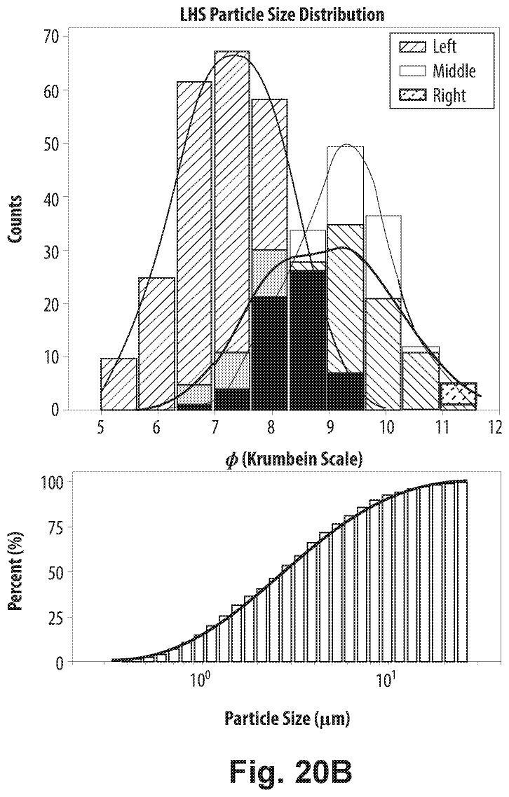

FIG. 18 shows the stress-strain plots for the various samples. The achieved maximum stress for the batch of 7 samples showed a wide scatter with an average 67.4 MPa and a standard deviation of 25.3 MPa.

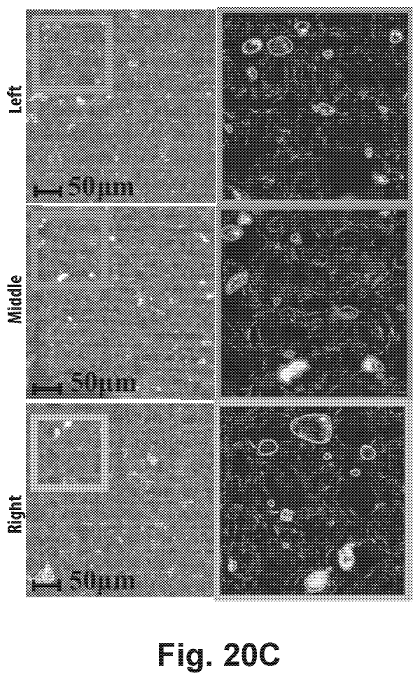

An exemplary stress-strain curve of sintered regolith is displayed in FIG. 19. During loading, repeated load drops occurred, and by means of the recorded videos, the load drops have been assigned to the formation of cracks. Chipping of small flakes and vertical cracking was observed. For the mechanical tests, the observed scatter of compressive strength data can be attributed to deviations of the specimen geometry from an ideal rectangular block. The loaded faces of the specimens were not exactly plane parallel which resulted in inhomogeneous stress distribution at the contact to the loading plates, crack formation and chipping of material. Therefore, the observed failure stresses are below the compressive strength specimens of the sintered regolith can achieve.

Accordingly, the inventors have shown the viability of obtaining distinct spectral peaks, successfully demonstrating using regolith manufactured through two different approaches. The samples exhibited consistent, and in some cases enhanced, Raman shift signals for key mineral groups such as olivine, feldspars, and pyroxene. Differences in Raman peak characteristics between samples could be attributed to the different manufacturing parameters; for instance, certain sintered samples reached temperatures as high as 1150° C., while certain resin-based composites may have experienced mechanically induced shifts during the curing process. This demonstrates not only the feasibility of optimizing sensors for specific applications but also the potential for selectively manufacturing regolith materials with compositions that exhibit the desired sensitivity for tailored sensor functionality.

The mechanical testing also demonstrated that the average compressive strength of the sintered regolith samples falls in the range of samples manufactured for construction. It is contemplated by the inventors based on their findings that the average compressive strength of sintered regolith samples are expected to significantly exceed that of lunar resin-regolith DLP samples. Although all Raman measurements are unaffected by low gravity, there may be changes to the spectra when the studies are conducted in space, for example due to different effects of heating and flow during the sintering or curing process in a low-gravity environment. However, the inventors have shown that, as described in certain embodiments, it is possible to create functional sensors from lunar regolith that can support operations in space. One having ordinary skill in the art, would appreciate in view of this disclosure, that the manufacturing process described herein may be further optimized and the response of the spectra can be calibrated with external stimuli.

In certain embodiments, a Digital Light Processing (DLP) of lunar regolith, slurry-based photopolymerization method for ceramic composites fabrication was used to create an exemplary embodiment of a functional sensor, which showed capabilities in the ability to control feature resolution and surface finish while maintaining mechanical properties. In certain embodiments, a finer geometry of the simulants (mean particle size of 6 to 7 μm) was specifically selected to enhance the DLP manufacturing process, such that the increased surface area enhances adhesion with the matrix. The processing approach for the functional materials using DLP also considers the weight fraction of simulant with respect to polymer. In certain embodiments, the desired regolith weight fraction selected was 10 wt % to ensure that sufficient particle concentration is achieved for spectral peaks to be collected. At the same time, high weight fractions will increase brittleness and delamination. The electrostatic clumping behavior of the finer particles must be considered when evaluating the quality of the functional materials manufactured, as this can affect performance. Dispersion characteristics are used as a key metric to achieve a homogeneous composite which is important for sensing performance. Dispersion studies in particulate composite manufacturing have been achieved using different approaches. The approach taken in this example is high-resolution optical images to identify the particles in the manufactured material and establish a weight fraction estimation.

The basis for the development of functional materials such as one or more embodiments of the functional sensors described herein can be achieved using the spectral emissions of the materials and their dependencies on external environments. Raman spectroscopy analyzes the small fraction of laser light that is inelastically scattered by a sample, resulting in an energy shift that provides detailed information about the material's structure and bonding. The resulting spectra reveal vibrational modes, characterized by their peak positions, which correspond to the crystal lattice of the sample. For each mode, the peak intensity, position shifts, and line width at half maximum (FWHM) provide insights into the material's concentration, stress state, and crystallinity. These properties can be calibrated and exploited for sensing applications. The inherent sensing properties of regolith and regolith composites are yet to be uncovered and the first step to doing so is to investigate the various Raman spectral peaks from the rich minerals within the various regolith compositions. The complex mineral composition of both LMS and LHS lunar regolith simulants can be summarized in Table 2.

The piezospectroscopic effect in composite materials has been gaining attention in non-destructive testing because of its potential for assessing stress conditions through signals generated by embedded particles. The basis of these measurements can be described, for example, when a crystal sample is subjected to uniform stress, such as hydrostatic pressure, evenly distributed strains can be quantified by measuring the unit-cell parameters of the crystal and comparing them to those of an unstrained reference crystal. This principle underlies the diffraction-based methods used to determine thermal expansion and equations of state for minerals. However, synchrotron X-ray diffraction (XRD) is expensive and unsuitable for the routine analysis of numerous grains or inclusions, but Raman spectroscopy offers a practical alternative. As described herein, Raman shifts in inclusions are typically interpreted as the result of hydrostatic pressure within the inclusion. These shifts are converted into pressure values using established pressure-wavenumber calibration curves. See for example, Table 2 below, which shows mineral compositions of exemplary LHS and LMS regolith simulants used within this study as well as the Raman peaks of the minerals within the lunar simulants.

TABLE 2

| | LHS | LMS | Known Raman |
|---|---|---|---|
| Mineral | wt % | wt % | Peaks (cm⁻¹) |
| Pyroxene | 0.3 | 32.8 | 331-338, 388, 657, 673-679, |
| (Ortho) | | | 1001-1007 |
| (Clino) | | | 317, 339, 653, 663-665, 995, |
| | | | 1005 |
| Glass-rich | 24.7 | 32 | 757, 970 |
| Basalt | | | |
| Anorthosite | 74.4 | 19.8 | 483-488, 503-505, 537-564 |
| Olivine | 0.2 | 11.1 | 815-826, 847-856 |
| Ilmenite | 0.4 | 4.3 | 681 |

Although the potential parameter-sensitive peaks and their dependencies that would yield absolute values of piezospectroscopic coefficients are unknown for our material of interest, preventing direct measurement of strain, stress, or other parameters, the inventors have explored material's responsiveness to the manufacturing process as an indirect approach. Specifically, the inventors have investigated the spectral changes in regolith samples, analyzing their transition from raw powders to manufactured states. Their findings described herein identified Raman peaks that could serve as reliable indicators for stress-sensing applications, and thus for the use of regolith powders in the manufacture of functional sensors.

In certain embodiments, the sensor samples were manufactured using both LMS-1D and LHS-1D powders. The manufacturing process for samples using DLP is summarized next. Both resin and regolith were added together and thoroughly mixed under a fume hood using a THINKY mixer AR-100 ensuring particle dispersion. This was followed by defoaming to mitigate entrapped microbubbles within the matrix. The samples were then printed using a DLP printer with a 5 μm layer thickness and cured with 405 nm UV light for 6 seconds per layer. Post-processing included an isopropyl alcohol wash and additional UV curing for 3 minutes on each side of the sample. A typical sample produced by this approach is shown in FIG. 15a, for example. Optical images of the surfaces of both the LMS-1D and LHS-1D samples were taken as shown in to conduct a dispersion analysis. Raman spectroscopy data was collected with a WITec Alpha 300RA Confocal Raman microscope equipped with a He:Ne 532 nm laser excitation source.

The particle distribution was quantified by analyzing 500× microscope images of each section. To enhance particle visibility, image contrast, saturation, and brightness were adjusted to better expose particle features. Each particle was then measured using the freehand tool in ImageJ software. The major and minor axes of the particles were recorded to calculate the mean particle size in pixel length, which was subsequently converted to micrometers. The particle size distribution was evaluated using the Krumbein phi scale (φ) to categorize particle types (e.g., silt, clay, colloid) and assess their dispersion during the DLP printing process:

$$ϕ = - {log}_{2} \frac{D}{{D}_{0}}$$

Where D represents the diameter of the particle in millimeters and 0 is a reference diameter set to 1 mm to ensure dimensional consistency within the equation.

In exemplary embodiments, the Raman measurements were performed with a commercial confocal and continuous wave (cw) Raman microscope laser (WITec alpha300 R system) with an excitation wavelength of 532 nm. The laser was focused to a spot of approximately 0.720 m, using a 100× magnification objective with a numerical aperture of 0.9. Thus, the beam spot size was smaller than the mean particle size of the regolith inclusions. The spectral resolution of 1 cm-1 was achieved with a groove density of 1800 g/mm. A minimum of 10 points were measured within a 200×200 μm sampling area, with an integration time of 2 seconds per point, accumulated 20 times. Raman measurements were conducted on a series of LMS and LHS DLP-printed regions. To process the data, an algorithm was scripted in Python for baseline correction using asymmetric least squares smoothing, followed by final profile smoothing with a Gaussian window spanning two observation points. Pseudo-Voigt profiles were used to deconvolute and fit peaks of interest to determine how the manufacturing process affects peak shifts, line width changes, and the material's potential for sensor applications.

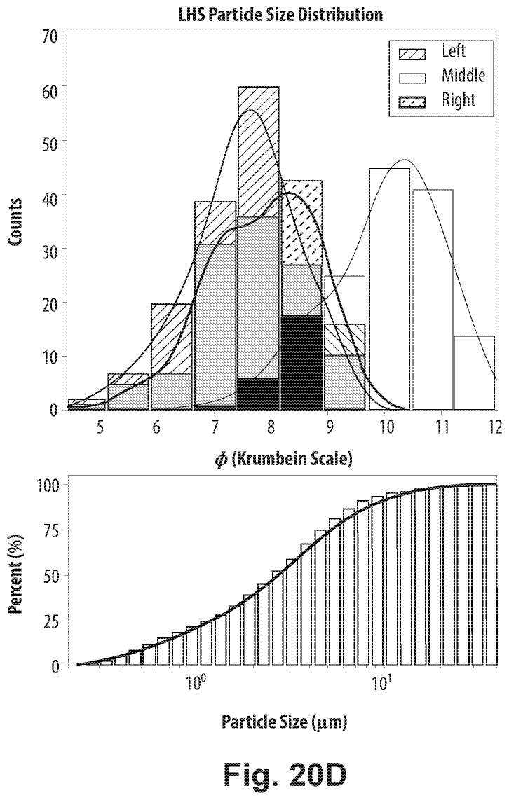

FIGS. 20a and 20b show the particle size dispersion of the LHS-1D samples along with the analysis using ImageJ and the final distribution of the particle sizes for the samples. Similarly, FIGS. 20c and 20d show the results for the LMS-1D sample. For both LMS and LHS samples, there is a good overall distribution of particle sizes that is representative of the simulant specifications. Consequently, the variation in the distribution of particles in the different sections of the sample can be attributed to the DLP process. The results show that the left sides of each sample have a distribution of larger particle sizes, while the middle has finer particles followed by a mix of sizes for the right side. One possible explanation for this is, as the left side representing the first layers in a typical DLP printing process where the slurry has a good mix of particle sizes with large particles dominating since they have not yet settled. Over time, when the layers of the middle section are printed, large particles have settled and only fine dust are deposited, resulting in small particle size distribution. As the last few layers are printed (making the right section), the remaining slurry is filled with some of the larger settled particles, and so the particle size distribution skews right once again.

The images demonstrate a difference in the surface roughness of the LMS-1D and LHS-1D DLP samples since the LHS-1D samples were polished and the actual print layers are no longer evident. The LMS-1D sample microscope images show the layers are approximately 50 μm thick. This is important to note, as the layers are thicker than even the largest possible particle size, which is ~30 μm. The results show that in manufacturing regolith into sensors, a processing approach that enables continuous mixing can improve settling and improve the homogeneity of the manufactured regolith composites. It is further contemplated that SEM images can reveal any voids or porosity in the process that contributes to inhomogeneity and can affect sensor properties, which can be used to further optimize and enhance the manufacturing process.

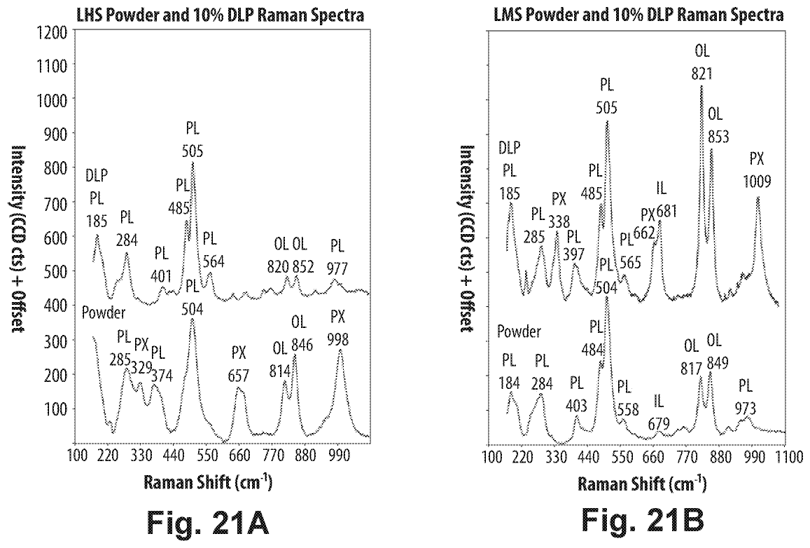

An average of the Raman spectra captured for LHS is shown in FIG. 21a for the manufactured DLP sample, top spectra, and the LHS powder sample, bottom spectra. Similarly, FIG. 21b shows the Raman spectra captured for LMS with the top spectra coming from the LMS powder and the bottom spectra from the manufactured DLP sample. Peak identification was performed using the peaks listed Table 1 above. From these spectra, anorthosite (plagioclase PL), pyroxene (PX), olivine (OL), and ilmenite (IL) were found to have a strong Raman response. Shifts in the peak locations can be easily observed from the powder to DLP spectra. Similarly, a separation of the peaks can also be observed for prominent peaks when comparing the spectra of the powder and DLP samples. This separation of the peaks is more easily observed in doublets such as the anorthosite peaks around 485 cm⁻¹ and 505 cm⁻¹ as well as the olivine peaks around 820 cm⁻¹ and 850 cm⁻¹.

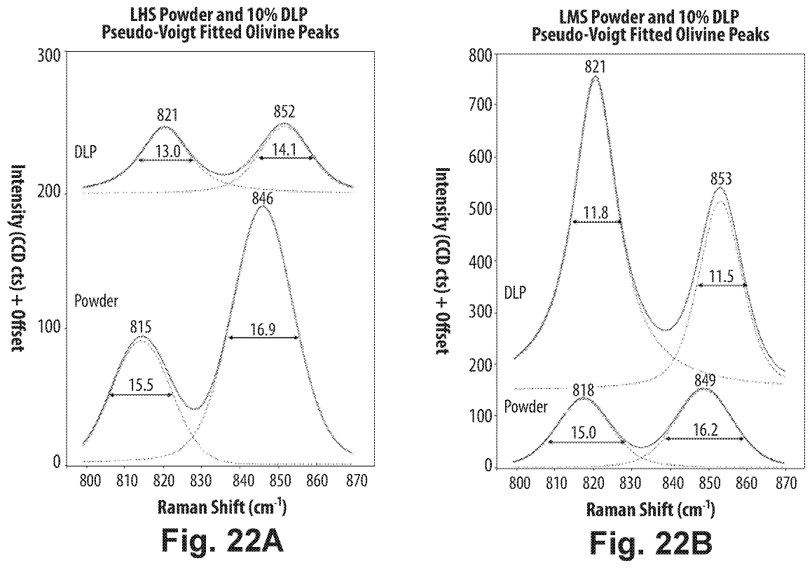

The olivine doublet at around 820 cm⁻¹ and 850 cm⁻¹ is of keen interest due to its strong Raman response and relative isolation from surrounding Raman peaks in both LHS and LMS. A pseudo-Voigt deconvolution and subsequent peak fitting were used on the 820 and 850 cm⁻¹ doublet peaks of olivine, which are shown in FIGS. 22a and 22b. FIG. 22a shows the pseudo-Voigt fitting results for the LHS DLP and LHS powder olivine doublet peaks and FIG. 22b shows the results for the LMS DLP and LMS powder olivine doublet peaks.

The peak center positions relative to the Raman shift, cm⁻¹, as well as the FWHMs of the peaks labeled within FIGS. 22a and 22b. Changes in signal intensities can most likely be attributed to differences in regolith simulant particle sizes and concentrations. The powder form of these simulants has a much higher particle density than the samples manufactured 10% with DLP. This effectively increases the likelihood of the laser probing and exciting the regolith simulant, relative to their compositional wt % distribution of minerals. DLP samples were also probed mostly through resin, which has a relatively poorer Raman response compared to the oxides comprising the regolith simulants. This would result in a reduced Raman spectra signal. It should be noted that LHS also has a much lower concentration of olivine as compared to LMS, which will decrease the potential intensity of the spectra and the likelihood of encountering olivine with small laser spot sizes.

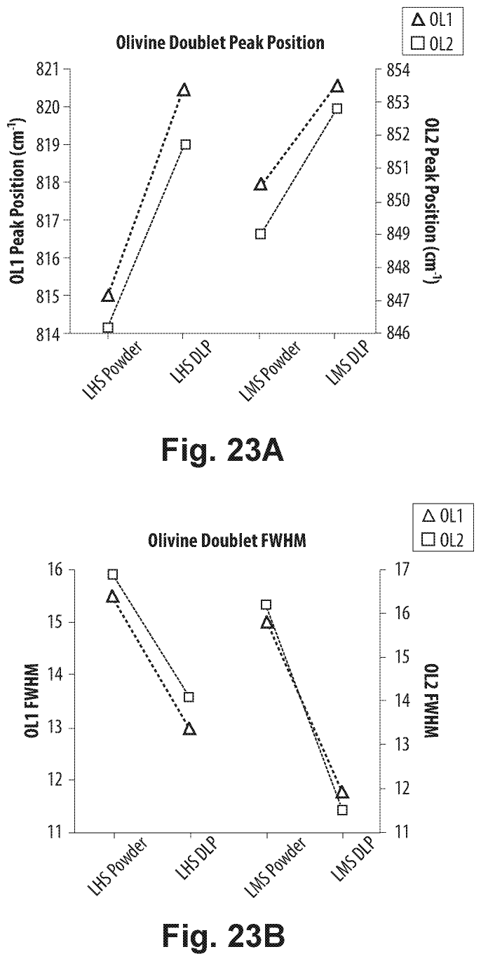

FIG. 23a plots the changes in the peak center position and FIG. 23b plots the changes in the FWHM for the LHS Powder, LHS DLP, LMS Powder, and LMS DLP samples. The 820 cm⁻¹ olivine peak is tracked by the blue triangle (OL1) while the 850 cm⁻¹ olivine peak is tracked by the orange square (OL2). In general, a blue shift, a rightward shift to a higher wavenumber, is observed for both olivine peaks in the peak center locations from its powder form to the manufactured DLP sample. These blue shifts are likely due to the DLP manufacturing process itself. This is because the DLP samples are of their respective regolith simulants embedded within a UV-curable resin. The blue shift for both simulant DLP samples suggests there is likely some residual stress induced onto the particles from the surrounding resin matrix, likely as a result of the shrinking and cooling of the resin during curing.

Additional tests, using the simulant powder form as a stress reference, can be performed to quantify the amount of residual stress the DLP manufactured samples experience as a result of the manufacturing process. The relationship between applied stress from a hydrostatic force and the shifting of the peak center positions can then be used to obtain and quantify the piezospectropic coefficient. Finding the piezospectropic coefficient, the slope between applied stress and peak shift, will give insight on the 820 cm⁻¹ and 850 cm⁻¹ olivine doublet's sensitivity to stress changes. A high sensitivity is vital for a high resolution regolith sensor measuring applied external stresses and temperature changes. It is contemplated herein that other Raman responsive minerals within the simulants, such as anorthosite, can be performed to observe their sensitivities and effectiveness to changing environmental conditions similar to conditions experienced in the extreme lunar environment.

FIGS. 22a-23b also show the FWHM of both olivine peaks narrowing when comparing the powder spectra with the DLP manufactured spectra. This reduction in the FWHM is likely due to the decrease in the number of regolith simulant particles being probed, reducing the number of different orientations and bindings of the molecules being measured within the probed laser region. However, it should be noted the number of different orientations of the particles may also be reduced as a result of the DLP manufacturing method. DLP being a form of 3D printing, there are directional layering created during the manufacturing process. This directional orientation will introduce anisotropic properties to the sample, resulting in a preferred orientation in the composite. In certain embodiments, this orientation of the molecules from the olivine would result in more sharp peaks, lowering FWHM. Alternatively, the decrease in FWHM may be attributed to the higher heat tolerance of the composite material, in contrast to the powder form, which is more prone to heat-induced deformation.

Additional work can observe how DLP manufacturing influences the orientation of the regolith simulants. A comparison with a non-inherently anisotropic manufacturing process of 10% weight LHS and LMS samples with the DLP samples is contemplated, for example, to provide insights on the spectral response properties, such as FWHM, of the regolith in embedded matrix composite systems and for sensor-based applications. A narrower FWHM, as a result of preferred orientations, would provide a sharper and more sensitive response toward external forces and conditions acting on that preferred direction while compromising on the sensor's response and reducing its sensitivity transverse to the preferred direction. In other words, the sensor would perform better in the preferred direction, with higher sensitivity, compared to any other direction, which may be ideal in specialized cases, such as uniaxial load monitoring. Conversely, a more broad FWHM, as a result of no preferred orientation, would provide a balanced response from the sensor towards external forces with a uniform sensitivity in any direction. In other words, the sensor would likely perform, overall, more balanced in any direction at a lower overall sensitivity, which might be ideal in more general applications for non-uniaxial external loading.

To summarize, in accordance with certain aspects of this disclosure, the inventors have therefore studied the functionality and feasibility of regolith for sensor-based development in extreme environments using regolith simulants comprised of minerals sourced from the lunar highland and lunar mare regions, LHS and LMS respectively. In this exemplary embodiment, these simulants were embedded at 10 wt. % into a resin through digital light processing (DLP) 3D printing. A dispersion study as well as Raman spectroscopy were utilized to determine the feasibility and functionality of using lunar regolith as reliable sensors. A comparison was made between the simulants in their powder forms as well as DLP 3D printed forms. The dispersion of particles, by size, was done throughout the DLP 3D printed sample. The Raman spectral peaks of the minerals were identified. An olivine doublet at 820 cm⁻¹ and 850 cm⁻¹ was selected as a potential marker for sensing capabilities due to its strong Raman response and relative isolation from other Raman signals. The shifts between the peak center positions and narrowing of the FWHM of the peaks were observed from the powder regolith to the DLP samples. These results serve as an initial baseline towards understanding the capabilities of lunar regolith-based composites to be used for lunar sensor-based applications.

In certain embodiments, further testing was conducted on one or more exemplary embodiments of the manufacturing material for the sensor, including evaluating the manufactured samples by assessing the particle behavior under compression loads. In certain embodiments, the setup consists of an integration between a compression test and Raman spectroscopy scanning system.

Sample sensors were prepared using one or more method described herein, for example, by manufacturing regolith simulant composites (LHS-1D) by 3D printing with DLP, 10 wt % regolith to ensure sufficient concentration to provide Raman intensity without issues of agglomeration. The epoxy resin and LHS were mixed together for three minutes, using the THINKY mixer AR-100. The mixture was then 3D printed using a DLP printer with a 5 μm layer thickness and cured with 405 nm UV light for 6 seconds per layer. For postprocessing, the samples were washed with isopropyl alcohol and additional UV curing for three minutes. In certain embodiments, the dimensions of the sample (the sensor) was 16 mm×3.8 mm×3.8 mm.

In this example, the Raman measurements were obtained using a WITec Alpha 300R Confocal Raman microscope. A laser with an excitation wavelength of 532 nm, and a 10× magnification objective were used to obtain the scans which are collected with a 1800 g/mm grating onto a CCD. The data was obtained by tracking a Plagioclase particle in the LHS-1D sample, identified by characteristic peaks and by doing a single spectrum at said particle with 20 accumulations. The data from the Raman scans present themselves a series of peaks that can be identified from Table 3. These peaks are then investigated for variations in peak position when the sample is loaded in compression.

TABLE 3

| | LHS | Known Raman |
|---|---|---|
| Mineral | wt % | Peaks (cm⁻¹) |
| Pyroxene | 0.3 | 331, 388, 657, 673, 1001 |
| (Ortho) | | 338, 679, 1007 |
| | | 225-325, 375-490, 650-750, |
| | | 800-1100, |
| | | 660, 678, 1006 |
| (Clino) | | 317, 663, 995 |
| | | 306, 339, 372, 653, 995 |
| | | 230, 327, 255, 360, 393, 665, |
| | | 1010 |
| | | 665, 1005 |
| Glass rich | 24.7 | 757, 970 |
| Basalt | | |
| Anorthosite | 74.4 | 485-488, 505, 557-564 |
| | | 504 |
| | | 483, 503 |
| Olivine | 0.2 | 815, 847 |
| | | 819, 848 |
| | | 810, 850, 914, 950 |
| | | 242, 295, 372, 558, 817, 840, |
| | | 921 (Fayalite) |
| | | 230, 307, 440, 588, 620, 826, |
| | | 858, 883, 967(Forsterite) |
| | | 826, 856 |
| Ilmenite | 0.4 | 681 |
| | | 600-700 |

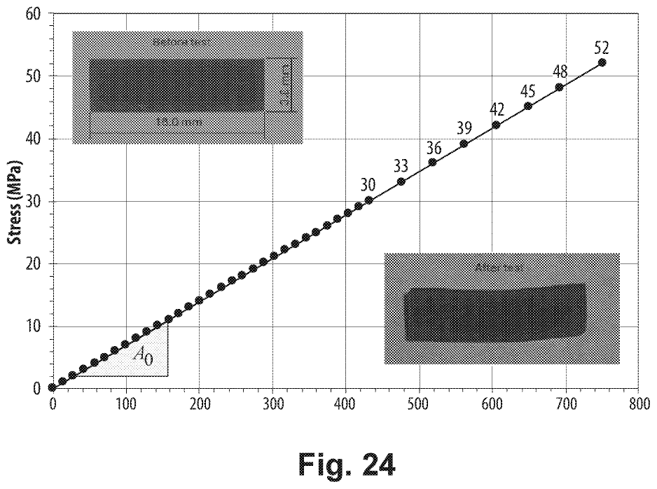

To evaluate the sensor functionality to compressive loads the DLP LHS-1D 10 wt % was placed in the Psylotech load frame (e.g., a uniaxial loading cell). In this example, an estimation of the maximum compression load was determined to be approximately 80 MPa using the modulus of the cured resin as a baseline. The sample was therefore tested up to 52 MPa. The first 30 MPa were loaded in steps of 1 MPa and after that the intervals increased to 3 MPa until the 52 MPa was reached. For each increment, Raman scans of the sample were taken. FIG. 24 shows the load profile, as well as images of an exemplary embodiment of a sensor compression tested, before and after experiencing the compression force. As shown, it was observed that the sample started buckling as the applied stress approached 52 MPa.

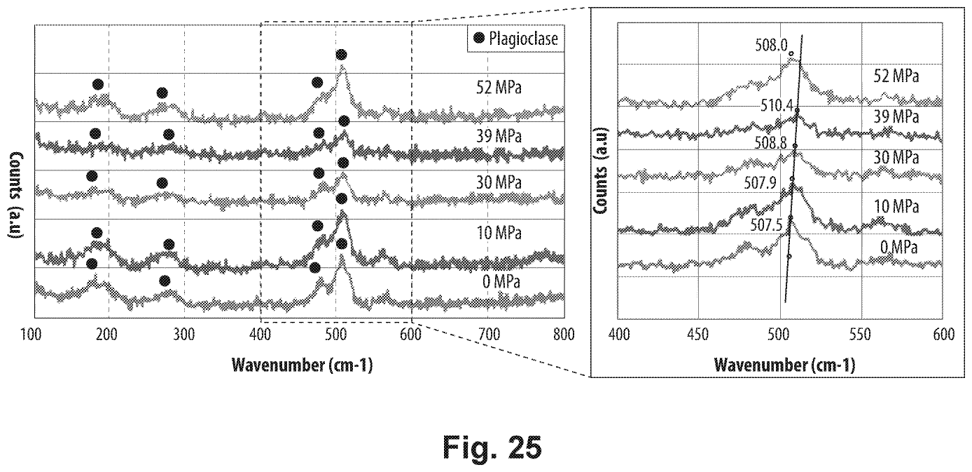

In this example, Raman spectroscopy was used to obtain the molecular structural behavior and stress-induced variations in the DLP LHS sample. The spectra collected at different compression stresses (0 MPa to 52 MPa) show a shift in the characteristic Raman peaks identified to be that of Plagioclase as shown in FIG. 25a. Here, the focus was set at the second more intense peak of the Plagioclase doublet which we identify as the 507 cm⁻¹ peak and the graph was zoomed in into the selected range as shown in FIG. 25b. This peak provides an initial measurement of 507.5 cm⁻¹ at 0 MPa and then produced a rightward shift with increasing applied stress until it reached 510.4 cm⁻¹ at 39 MPa. As Raman spectroscopy provides insight into the atomic structure of particles, there are two factors that influence the peaks: (i) the mechanical parameters, such as atomic mass, bond strength, or geometry (interatomic distance); and (ii) the charge transfer parameter, such as band structure, or electronic insertion.

As shown, the compression force does not have any effect on the charge of the particle but it does affect the geometry by making the interatomic distances smaller. This explains the existence of the rightward shift. At 52 MPa, the same peak can be observed at 508.0 cm⁻¹ and buckling can be observed in the image from FIG. 24. The buckling of the sample modifies the way the stress is acting on it. This allows for the interatomic distance of the particle to increase, which generates the leftward shift. The buckling and the left shift of the Raman peak at 52 MPa would indicate the failure point of the sample.

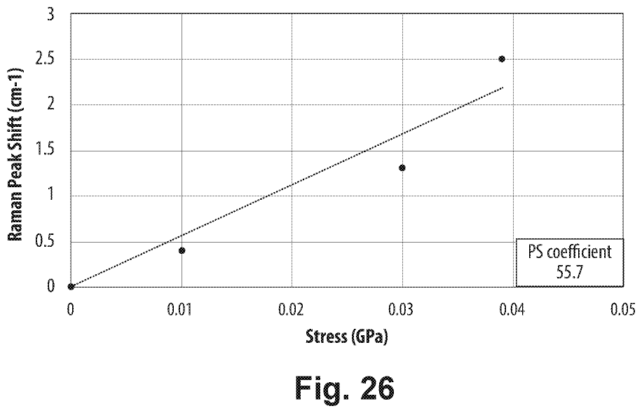

As previously discussed, there is a correlation between the right shifting of the Raman peaks and the stress the sample is undergoing. This relationship is described in FIG. 26 which shows the obtained slope for the peak shifts at different loads. The slope represents the sensitivity of the sample to mechanical loading, providing insight on its use as a stress-sensing material. This slope, also known as the piezospectroscopic (PS) coefficient, is determined to be 55.7 cm⁻¹/GPa for the 507 cm⁻¹ Plagioclase peak. FIG. 26 shows a positive linear trend, this confirms that within this range, the DLP sample exhibits elastic behavior. The steeper the slope the more sensitive the material is, while the shallower the less responsive to applied stress. For this sample a moderate slope can be observed, not to steep and not to shallow, which indicates that the material can detect moderate stress changes with measurable Raman peaks. Although, the effectiveness decreases at higher loads.

The fact that the particle being measured with Raman is experiencing a shift when load is applied indicates there is good bonding between the particles of LHS in the resin, since this means the particle is also experiencing the compression in addition to the resin through load transfer. In this example, the shift for 52 MPa was not considered in this plot because the sample was no longer in uniaxial compression at this applied stress and this data point is a deviation from elastic behavior. This deviation is likely due to the mechanical failure (buckling) the sample experienced at that load.

Accordingly, this exemplary embodiment of a sensor and sensor testing demonstrated the potential of using LHS-1D to manufacture functional sensors in extreme environments. The DLP manufacturing process was used to create samples with 10 wt % LHS and epoxy. The Raman spectroscopy of this sample provided measurable shifts in the characteristic spectra of Plagioclase under applied compressive stress. The observed rightward shift of those peaks reveals a stress-dependent response with a PS coefficient of 55.7 cm⁻¹/GPa. This indicates the possibility of using regolith-based composites as sensing materials. However, there was a leftward shift at 52 MPa, and a buckling of the sample, suggesting a limit to the allowable stress. The inventor's findings provide insight into the use of in-situ materials for space sensor applications.

Therefore, in accordance with at least one aspect of this disclosure, the inventors provide a sensor structure which comprises a body configured to be placed on a structure or surface to monitor a load on the structure or surface to which the body is applied. The body can be additively manufactured using an additive manufacturing medium comprising, at least, regolith of a celestial body. In certain embodiments, the regolith can be one or more of: a Lunar Mare regolith, a Lunar Mare regolith simulant (LMS-1), a Lunar Mare Dust regolith, a Lunar Mare Dust regolith simulant (LMS-1D), a Lunar Highlands Dust regolith, a Lunar Highlands dust regolith simulant (LHD-1D), or Martian regolith.

As discussed, above, the regolith includes thermoluminescent and/or photoluminescent particles, which can be irradiated while under load using spectroscopy (e.g., Raman spectroscopy) to observe the thermoluminescent and/or photoluminescent particles response to the load. Spectral peaks for the body under load can be compared to one or more known spectral peaks for a test body. The known spectral peaks for the test body represent one or more conditions, for example, a known compressive load where the structure will begin to fail or a known thermal load where the structure will begin displaying properties that render the structure unstable. Accordingly, by comparing the spectral peaks obtained from the body to the known spectral peaks for the test body, a condition for the body can be obtained, which is then indicative of a condition for the structure or surface to which the body is applied (e.g., therefore assessing mechanical properties of planetary/lunar vehicles, spacecrafts, landers, habitats, exploration instruments in response to external stimuli). Accordingly, as described herein the sensor body can act as a transducer of the sensor system where the sensor body converts signals indicative of a load acting on the sensor body (e.g., compressive load, thermal load, chemical load modifying the molecular structure of the sensor body) into a form observable by spectroscopy.

In certain embodiments, the composition of the additive manufacturing medium (e.g., the regolith selected, or the relative amounts of regolith to matrix) can be selected as a function of the load to be monitored by the sensor structure and or a desired sensor sensitivity to the load to be monitored by the sensor structure. In certain embodiments, the load to be monitored by the sensor structure can be one or more of a compressive load, a thermal load, and/or a chemical load, and each type of load can be best assessed with different regolith, or using sensors manufactured using different medium compositions. For example, sintered sensors may exhibit higher thresholds for measuring compressive load than sensors manufactured using DLP.

In accordance with at least one aspect of this disclosure, a system for additively manufacturing sensors from celestial body regolith includes a spectrometer configured to receive and analyze regolith to produce regolith data and an additive manufacturing machine associated with the spectrometer to receive the regolith data and to manufacture a sensor based on the regolith data to perform a predetermined sensor function. In certain embodiments, the predetermined sensor function includes one or more of: monitoring a compressive load, monitoring a thermal load, and/or monitoring a chemical load.

In accordance with at least one aspect of this disclosure, a method includes additively manufacturing a sensor structure body (e.g., any one or more embodiments of a sensor structure shown and described herein) using an additive manufacturing medium comprising, at least, regolith of a celestial body.

As will be appreciated by those skilled in the art, aspects of the present disclosure may be embodied as a system, method or computer program product. Accordingly, aspects of this disclosure may take the form of an entirely hardware embodiment, an entirely software embodiment (including firmware, resident software, micro-code, etc.), or an embodiment combining software and hardware aspects, all possibilities of which can be referred to herein as a “circuit,” “module,” or “system.” A “circuit,” “module,” or “system” can include one or more portions of one or more separate physical hardware and/or software components that can together perform the disclosed function of the “circuit,” “module,” or “system”, or a “circuit,” “module,” or “system” can be a single self-contained unit (e.g., of hardware and/or software). Furthermore, aspects of this disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of this disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of this disclosure may be described above with reference to flowchart illustrations and/or block diagrams of methods, apparatus (systems) and computer program products according to embodiments of this disclosure. It will be understood that each block of any flowchart illustrations and/or block diagrams, and combinations of blocks in any flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in any flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified herein.

Those having ordinary skill in the art understand that any numerical values disclosed herein can be exact values or can be values within a range. Further, any terms of approximation (e.g., “about”, “approximately”, “around”) used in this disclosure can mean the stated value within a range. For example, in certain embodiments, the range can be within (plus or minus) 20%, or within 10%, or within 5%, or within 2%, or within any other suitable percentage or number as appreciated by those having ordinary skill in the art (e.g., for known tolerance limits or error ranges).

The articles “a”, “an”, and “the” as used herein and in the appended claims are used herein to refer to one or to more than one (i.e., to at least one) of the grammatical object of the article unless the context clearly indicates otherwise. By way of example, “an element” means one element or more than one element.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.”

Any suitable combination(s) of any disclosed embodiments and/or any suitable portion(s) thereof are contemplated herein as appreciated by those having ordinary skill in the art in view of this disclosure.

The embodiments of the present disclosure, as described above and shown in the drawings, provide for improvement in the art to which they pertain. While the subject disclosure includes reference to certain embodiments, those skilled in the art will readily appreciate that changes and/or modifications may be made thereto without departing from the spirit and scope of the subject disclosure.

What is claimed is:

1. A sensor structure, comprising:
a body configured to be placed on a structure or surface to monitor a load on the structure or surface to which the body is applied,
wherein the body is additively manufactured using an additive manufacturing medium comprising, at least, regolith of a celestial body.

2. The sensor structure of claim 1, wherein the regolith includes thermoluminescent and/or photoluminescent particles, and wherein sensor data is collected from the sensor structure by irradiating the body while under load and observing the thermoluminescent and/or photoluminescent particles within the body for a response to the load.

3. The sensor structure of claim 2, wherein the sensor data is generated by utilizing Raman spectroscopy to observe load-induced variations in the body by comparing spectral peaks for the body under load to one or more known spectral peaks for a test body, wherein the known spectral peaks for the test body represent one or more conditions such that comparison of the spectral peaks obtained from the body to the known spectral peaks for the test body provides a condition for the body which is indicative of a condition for the structure or surface to which the body is applied.

4. The sensor structure of claim 3, wherein the condition includes one or more of: a stable condition, a partially stable condition, and/or a close to failure condition.

5. The sensor structure of claim 2, wherein a composition of the additive manufacturing medium is selected as a function of the load to be monitored by the sensor structure and or a desired sensor sensitivity to the load to be monitored by the sensor structure.

6. The sensor structure of claim 5, wherein the load to be monitored by the sensor structure is one or more of a compressive load, a thermal load, and/or a chemical load.

7. The sensor structure of claim 1, wherein the body is additively manufactured using a laser-assisted sintering process.

8. The sensor structure of claim 7, wherein the additive manufacturing medium includes additive manufacturing powder formed from the regolith and does not include a binder or matrix.

9. The sensor structure of claim 7, wherein the laser-assistant sintering process operates at a temperature of about 1100° C. to about 1200° C.

10. The sensor structure of claim 1, wherein the body is a composite body additively manufactured using digital light processing (DLP).

11. The sensor structure of claim 10, wherein the additive manufacturing medium is a mixture of celestial body regolith and a binder or matrix.

12. The sensor structure of claim 11, wherein the binder or matrix is a resin, including a UV resin or an epoxy resin.

13. The sensor structure of claim 11, wherein the additive manufacturing medium has a composition of about 20% regolith by volume or less.

14. The sensor structure of claim 13, wherein the additive manufacturing medium has a composition of about 10% regolith by volume or less.

15. The sensor structure of claim 14, wherein the additive manufacturing medium has a composition of about 1% to about 5% regolith by volume, with the remainder being the resin.

16. The sensor structure of claim 1, wherein a particle size of the regolith is between about 10 microns to about 30 microns.

17. The sensor structure of claim 1, wherein the regolith is one or more of: a Lunar Mare regolith, a Lunar Mare regolith simulant (LMS-1), a Lunar Mare Dust regolith, a Lunar Mare Dust regolith simulant (LMS-1D), a Lunar Highlands Dust regolith, a Lunar Highlands dust regolith simulant (LHD-1D), or Martian regolith.

18. A system for additively manufacturing sensors from celestial body regolith, comprising:
a spectrometer configured to receive and analyze regolith to produce regolith data; and
an additive manufacturing machine associated with the spectrometer to receive the regolith data and to manufacture a sensor based on the regolith data to perform a predetermined sensor function.

19. The sensor structure of claim 18, wherein the predetermined sensor function includes one or more of: monitoring a compressive load, monitoring a thermal load, and/or monitoring a chemical load.

20. A method, comprising:
additively manufacturing a sensor structure body using an additive manufacturing medium comprising, at least, regolith of a celestial body.
